(19) United States
(12) Patent Application Publication
(10) Pub. No.: US 2013/0079029 A1
(43) Pub. Date: Mar. 28, 2013

(54) Multi-modality communication network auto-activation

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(21) Appl. No.: 13/373,824

(22) Filed: Nov. 30, 2011

Related U.S. Application Data
(63) Continuation-in-part of application No. 13/200,741, filed on Sep. 28, 2011.
Application No. 13/200,741 is a continuation-in-part of application No. 13/200,805, filed on Sep. 30, 2011.
Application No. 13/200,805 is a continuation-in-part of application No. 13/200,804, filed on Sep. 30, 2011.
Application No. 13/200,804 is a continuation-in-part of application No. 13/317,985, filed on Oct. 31, 2011.
Application No. 13/317,985 is a continuation-in-part of application No. 13/317,983, filed on Oct. 31, 2011.
Application No. 13/317,983 is a continuation-in-part of application No. 13/317,987, filed on Oct. 31, 2011.
Application No. 13/317,987 is a continuation-in-part of application No. 13/373,643, filed on Nov. 21, 2011.

(51) Int. Cl. H04W 88/06; H04W 24/00

(52) U.S. Cl. 455/456.1; 455/552.1

(57) ABSTRACT

Disclosed herein are example embodiments for multi-modality communication with network auto-activation. By way of example but not limitation, a network communication device may determine that user interaction with a communication device is to correspond to a second communication modality based, at least partly, on one or more parameters relating to utilization of the communication device. The network communication device may cause activation of at least one feature that causes a communication corresponding to a first communication modality to comprise a multi-modality communication corresponding to the first communication modality and to a second communication modality responsive at least partly to a determination that user interaction with a communication device is to correspond to the second communication modality.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements:
the present application constitutes a continuation-in-part of U.S. patent application Ser. No. 13/200,741 (Atty. Docket No. SE1-0304-US), entitled “MULTI-MODALITY COMMUNICATION”, naming Royce A. Levien, Richard T. Lord, Robert W. Lord, Mark A. Malamud, John D. Rinaldo Jr. as inventors, filed 28 Sep. 2011, which is currently co-pending, or is an application of which a currently co-pending application is entitled to the benefit of the filing date;
the present application constitutes a continuation-in-part of U.S. patent application Ser. No. 13/200,805 (Atty. Docket No. SE1-0305-US), entitled “MULTI-MODALITY COMMUNICATION PARTICIPATION”, naming Royce A. Levien, Richard T. Lord, Robert W. Lord, Mark A. Malamud, John D. Rinaldo Jr. as inventors, filed 30 Sep. 2011, which is currently co-pending, or is an application of which a currently co-pending application is entitled to the benefit of the filing date;
the present application constitutes a continuation-in-part of U.S. patent application Ser. No. 13/200,804 (Atty. Docket No. SE1-0306-US), entitled “USER INTERFACE FOR MULTI-MODALITY COMMUNICATION”, naming Royce A. Levien, Richard T. Lord, Robert W. Lord, Mark A. Malamud, John D. Rinaldo Jr. as inventors, filed 30 Sep. 2011, which is currently co-pending, or is an application of which a currently co-pending application is entitled to the benefit of the filing date;
the present application constitutes a continuation-in-part of U.S. patent application Ser. No. 13/______ (Atty. Docket No. SE1-0307-US), entitled “MULTI-MODALITY COMMUNICATION WITH CONVERSION OFFLOADING”, naming Royce A. Levien, Richard T. Lord, Robert W. Lord, Mark A. Malamud, John D. Rinaldo Jr. as inventors, filed 31 Oct. 2011, which is currently co-pending, or is an application of which a currently co-pending application is entitled to the benefit of the filing date;
the present application constitutes a continuation-in-part of U.S. patent application Ser. No. 13/______ (Atty. Docket No. SE1-0308-US), entitled “MULTI-MODALITY COMMUNICATION WITH INTERCEPTIVE CONVERSION”, naming Royce A. Levien, Richard T. Lord, Robert W. Lord, Mark A. Malamud, John D. Rinaldo Jr. as inventors, filed 31 Oct. 2011, which is currently co-pending, or is an application of which a currently co-pending application is entitled to the benefit of the filing date;
the present application constitutes a continuation-in-part of U.S. patent application Ser. No. 13/______ (Atty. Docket No. SE1-0309-US), entitled “MULTI-MODALITY COMMUNICATION INITIATION”, naming Royce A. Levien, Richard T. Lord, Robert W. Lord, Mark A. Malamud, John D. Rinaldo Jr. as inventors, filed 31 Oct. 2011, which is currently co-pending, or is an application of which a currently co-pending application is entitled to the benefit of the filing date; and
the present application constitutes a continuation-in-part of U.S. patent application Ser. No. 13/______ (Atty. Docket No. SE1-564-US), entitled “MULTI-MODALITY COMMUNICATION AUTO-ACTIVATION”, naming Royce A. Levien, Richard T. Lord, Robert W. Lord, Mark A. Malamud, John D. Rinaldo Jr. as inventors, filed 21 Nov. 2011, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

### BRIEF DESCRIPTION OF THE FIGURES

FIG. 1 is a schematic diagram of a network communication device and two communication devices that may participate in an example communication in accordance with certain example embodiments.

FIG. 2 is a schematic diagram of communication devices that may be involved in a communication relating to at least two communication modalities or one or more converters responsive to at least one example intimacy setting in accordance with certain example embodiments.

FIGS. 3A-3H are schematic diagrams illustrating different communication path or conversion scenarios for different example communications in accordance with certain example embodiments.

FIG. 4 is a schematic diagram of an example communication device including one or more example components in accordance with certain example embodiments.

FIG. 5 is a schematic diagram of an example network communication device including one or more example components in accordance with certain example embodiments.

FIG. 6A is a flow diagram illustrating an example method for implementing auto-activation with regard to multi-modality communication at least partially by a communication device in accordance with certain example embodiments.

FIG. 6B is a flow diagram illustrating an example method for automatically activating a feature for multi-modality communication at least partially by a communication device in accordance with certain example embodiments.

FIG. 7A is a schematic diagram including an example communication device to automatically activate a feature for multi-modality communication in accordance with certain example embodiments.

FIG. 7B is a schematic diagram including a communication device that depicts example additional or alternative aspects for automatically activating a feature for multi-modality communication in accordance with certain example embodiments.

FIG. 7C is a schematic diagram of a communication device that depicts example additional or alternative aspects for automatically activating a feature for multi-modality communication in accordance with certain example embodiments.

FIG. 8 is a flow diagram illustrating an example method for implementing auto-activation with regard to multi-modality communication at least partially by a network communication device in accordance with certain example embodiments.

FIG. 9A is a schematic diagram including an example network communication device to automatically activate a feature for multi-modality communication in accordance with certain example embodiments.

FIG. 9B is a schematic diagram including a network communication device that depicts example additional or alternative aspects for automatically activating a feature for multi-modality communication in accordance with certain example embodiments.

FIG. 9C is a schematic diagram including a network communication device that depicts example additional or alternative aspects for automatically activating a feature for multi-modality communication in accordance with certain example embodiments.

FIG. 10A is a flow diagram illustrating an example method for automatically activating at a network communication device a feature for multi-modality communication in accordance with certain example embodiments.

FIGS. 10B-10K depict example additions or alternatives for a flow diagram of FIG. 10A in accordance with certain example embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

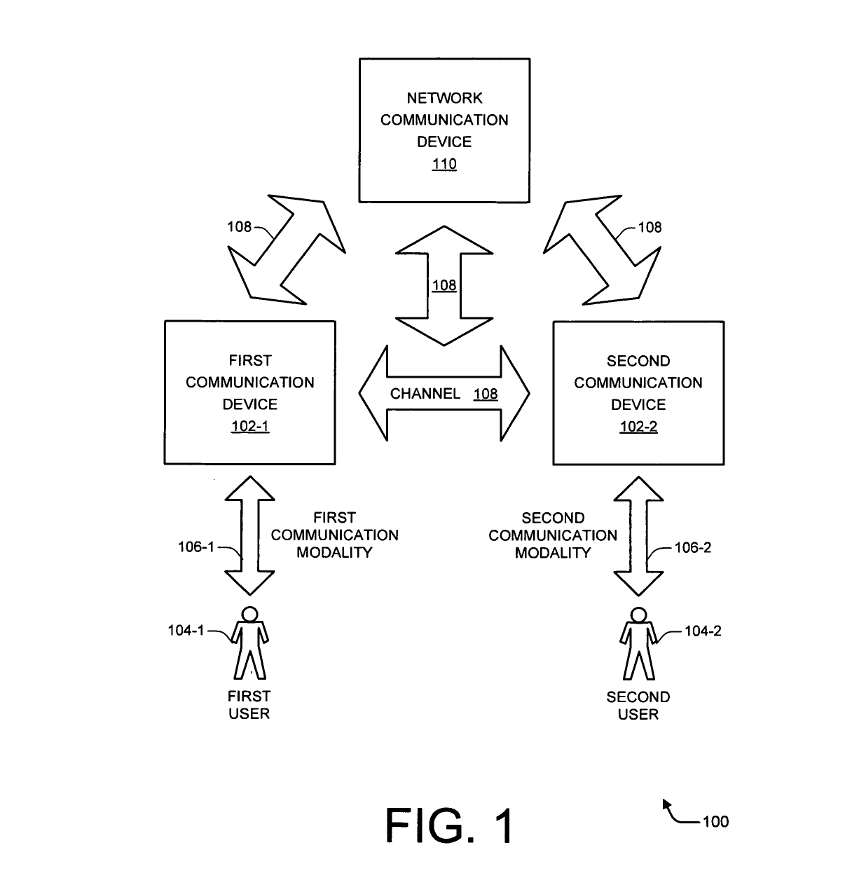

FIG. 1 is a schematic diagram 100 of a network communication device and two communication devices that may participate in an example communication in accordance with certain example embodiments. As shown in FIG. 1, by way of example but not limitation, schematic diagram 100 may include communication devices 102, users 104, communication modalities 106, at least one channel 108, or at least one network communication device 110. More specifically, schematic diagram 100 may include a first communication device 102-1, a first user 104-1, a first communication modality 106-1, a second communication device 102-2, a second user 104-2, a second communication modality 106-2, one or more channels 108, or at least one network communication device 110.

For certain example embodiments, a user 104 may be associated with at least one communication device 102. A user 104 may be interacting with a communication device 102 via at least one communication modality 106. Communication devices 102 may comprise, by way of example but not limitation, a mobile phone, a mobile terminal, a laptop or notebook computer, a personal digital assistant (PDA), a netbook, an entertainment appliance (e.g., a television, a gaming console, a set-top box, a music player, some combination thereof, etc.), a smart phone, a portable gaming device, a user equipment, a tablet or slate computer, a home phone, a desktop computer, a personal navigation device (PND), a vehicle with user-accessible communication capabilities, a private branch exchange (PBX)-based phone, videoconferencing equipment, any combination thereof, and so forth. A user 104 may comprise, by way of example only, at least one person. Example communication modalities 106 may include, by way of example but not limitation, a textual communication modality (e.g., wherein text may be communicated such as via a text message), a vocal communication modality (e.g., wherein sounds may be communicated such as via a voice call or teleconference), a visual communication modality (e.g., wherein moving images may be communicated such as via a video call or video conference), any combination thereof, and so forth.

For certain example embodiments, first user 104-1 may be associated with first communication device 102-1. First user 104-1 may be interacting with first communication device 102-1 via at least one first communication modality 106-1. Second user 104-2 may be associated with second communication device 102-2. Second user 104-2 may be interacting with second communication device 102-2 via at least one second communication modality 106-2. First communication device 102-1 or first user 104-1 may be participating in at least one communication (not explicitly shown in FIG. 1) with second communication device 102-2 or second user 104-2 via one or more channels 108. A communication may comprise, by way of example but not limitation, a transmission of data, a reception of data, an exchange of data, a flow of data (e.g., between or among two or more endpoints), any combination thereof, and so forth.

For certain example embodiments, a channel 108 may comprise, by way of example but not limitation, one or more of: at least one wired link, at least one wireless link, at least part of public network, at least part of a private network, at least part of a packet-switched network, at least part of a circuit-switched network, at least part of an infrastructure network, at least part of an ad hoc network, at least part of a public-switched telephone network (PSTN), at least part of a cable network, at least part of a cellular network connection, at least part of an Internet connection, at least part of a Wi-Fi connection, at least part of a WiMax connection, at least part of an internet backbone, at least part of a satellite network, at least part of a fibre network, multiple instances of any of the above, any combination of the above, and so forth. A channel 108 may include one or more nodes (e.g., a telecommunication node, an access point, a base station, an internet server, a gateway, an internet or telecommunication switch, any combination thereof, etc.) through which signals are propagated. A network communication device 110 may comprise, by way of example but not limitation, at least one node through which signals are propagated for a communication that includes a first communication device 102-1 or a second communication device 102-2. A network communication device 110 may communicate with first communication device 102-1 or second communication device 102-2 using any one or more of multiple channels 108, a few examples of which are illustrated in schematic diagram 100.

For certain example implementations, a communication may be initiated by first communication device 102-1, first user 104-1, second communication device 102-2, second user 104-2, any combination thereof, and so forth. For certain example implementations, first communication modality 106-1 may comprise at least one different communication modality from second communication modality 106-2. Furthermore, for certain example implementations, first communication modality 106-1 or second communication modality 106-2 may change from one communication modality to another communication modality during a single communication, across different communications, and so forth. Additionally or alternatively, another (e.g., different) communication modality may be referred to herein as a “third communication modality” or a “fourth communication modality”, for example.

Moreover, it should be understood that the terms “first” or “second” may, depending on context, be a matter of perspective. For instance, a communication device 102 or a user 104 or a communication modality 106 may be considered a first one at a given moment, for a given communication, from a given perspective, etc. but may be considered a second one at a different moment, for a different communication, from a different perspective, etc. However, one of ordinary skill in the art will recognize that the term “first” or “second” (or “third” or “fourth” etc.) may serve, depending on context, to indicate that different interactions, acts, operations, functionality, a combination thereof, etc. may be occurring at, may be more closely associated with, a combination thereof etc. one side, aspect, location, combination thereof, etc. of a particular communication as compared to another side, aspect, location, combination thereof, etc. of the particular communication. For example, one signal including data may be transmitted from a first communication device 102-1 and received at a second communication device 102-2, or another signal including data may be transmitted from a second communication device 102-2 and received at a first communication device 102-1.

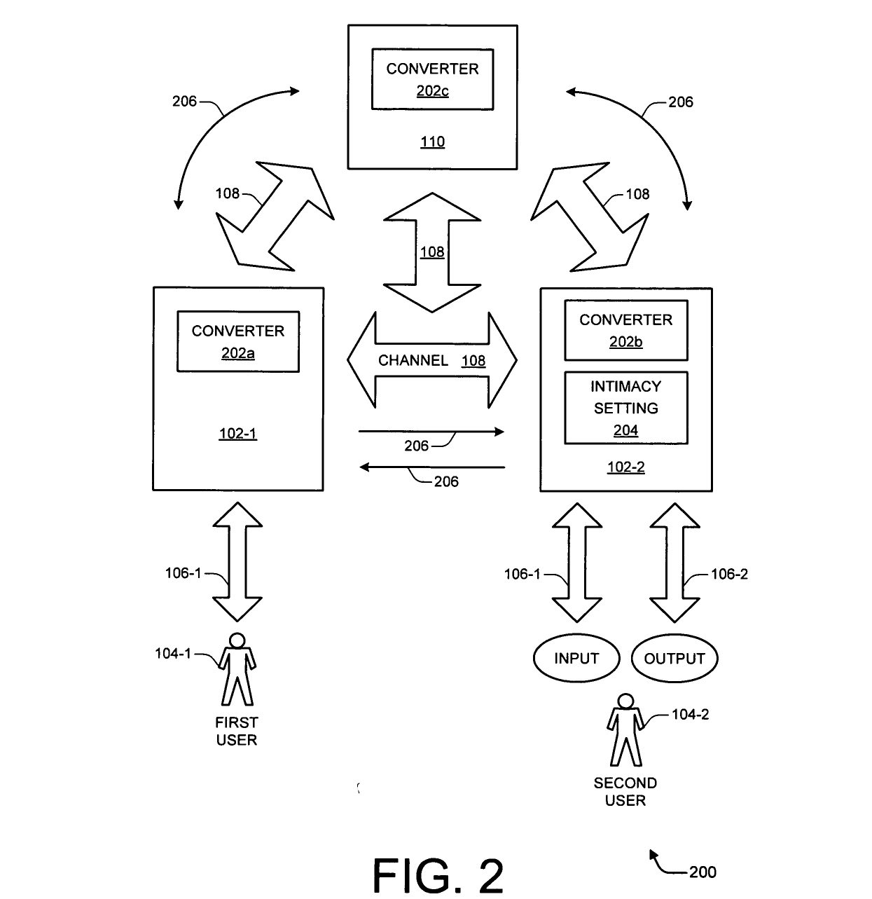

FIG. 2 is a schematic diagram 200 of communication devices that may be involved in a communication relating to at least two communication modalities or one or more converters responsive to at least one example intimacy setting in accordance with certain example embodiments. As shown in FIG. 2, by way of example but not limitation, schematic diagram 200 may include communication devices 102, users 104, communication modalities 106, at least one channel 108, at least one network communication device 110, or one or more signals 206. More specifically, schematic diagram 200 may include a first communication device 102-1, a first user 104-1, a first communication modality 106-1, a second communication device 102-2, a second user 104-2, a second communication modality 106-2, one or more channels 108, at least one network communication device 110, or one or more signals 206. Furthermore, one or more of first communication device 102-1, second communication device 102-2, or network communication device 110 may include at least one converter 202 (e.g., a converter 202a, a converter 202b, or a converter 202c, respectively). Additionally or alternatively, at least second communication device 102-2 may include (e.g., store, establish, have access to, a combination thereof, etc.) at least one intimacy setting 204.

For certain example embodiments, first user 104-1 may be associated with first communication device 102-1. First user 104-1 may be interacting with first communication device 102-1 via at least one first communication modality 106-1. Second user 104-2 may be associated with second communication device 102-2. Second user 104-2 may be interacting with second communication device 102-2 via at least one second communication modality 106-2. Additionally or alternatively, second user 104-2 may be interacting with second communication device 102-2 via at least one first communication modality 106-1. As described further herein below, at least one user 104 for at least one side of a communication may be engaged in a multi-modality communication by interacting with an associated communication device 102 using two or more communication modalities 106, such as a first communication modality 106-1 and a second communication modality 106-2. First communication modality 106-1 may differ from second communication modality 106-2. First communication device 102-1 or first user 104-1 may be participating in at least one communication with second communication device 102-2 or second user 104-2 via one or more signals 206, a few examples of which are shown in FIG. 2. Signals 206 may propagate via one or more channels 108. Signals 206, by way of example but not limitation, may comprise, electrical signals, magnetic signals, electromagnetic signals, photonic signals, wireless signals, wired signals, multiples ones thereof, any combination thereof, and so forth.

For certain example embodiments, a second communication device 102-2 may receive one or more signals 206 corresponding to a first communication modality 106-1. A second communication device 102-2 may respond to one or more received signals 206 corresponding to first communication modality 106-1 based at least partly on second user 104-2 interaction via a second communication modality 106-2 in accordance with at least one intimacy setting 204. By way of example but not limitation, at least one intimacy setting 204 may indicate what kind or kinds of one or more communication modalities 106 a user 104 is willing to expose for at least one communication.

For certain example embodiments, at least one intimacy setting 204 may indicate how a user 104 is to interact with a communication device 102 with respect to a given communication without condition (e.g., a user may limit any current communications to text, to voice, to video, etc.). Additionally or alternatively, at least one intimacy setting 204 may indicate how a user 104 is to interact with a communication device with respect to a given communication on a conditional basis. By way of example only, a user 104 may indicate a communication modality (e.g., as represented by at least one intimacy setting 204) in at least partial dependence on whether an associated communication device 102 initiated a communication or terminated a communication. For instance, at least one intimacy setting 204 may indicate that communications are to be initiated using an interaction in accordance with a voice communication modality, but the at least one intimacy setting 204 may indicate that communications are to be terminated (e.g., accepted, received, a combination thereof, etc.) using a textual communication modality.

As another example of a conditional intimacy setting 204, a second user 104-2 may indicate a second communication modality 106-2 in at least partial dependence on a first communication modality 106-1. For instance, at least one intimacy setting 204 may indicate that if a first communication modality 106-1 corresponds to text, a second communication modality 106-2 is also to correspond to text; furthermore, the at least one intimacy setting 204 may indicate that if a first communication modality 106-1 corresponds to voice, a second communication modality 106-2 is to correspond to text; moreover, the at least one intimacy setting 204 may indicate that if a first communication modality 106-1 corresponds to video, a second communication modality 106-2 is to correspond to voice. Additionally or alternatively, a second user 104-2 may indicate a second communication modality 106-2 that is based at least partially on: an identity of a first user 104-1; a time of day, day of week, a combination thereof, etc.; an environmental condition (e.g., an ambient lighting level, a level or type of movement—e.g. vehicle motion may be detected, a combination thereof, etc.) detectable by sensor(s) or otherwise determinable by a device; a calendar; any combination thereof; and so forth. However, claimed subject matter is not limited to any particular examples.

For certain example embodiments, a user 104 may interact with a single device (or multiple devices) for a single communication using one communication modality 106. Additionally or alternatively, a user 104 may interact with a single device (or multiple devices) for a single communication using two or more communication modalities 106. For certain example implementations, and as illustrated with respect to second communication device 102-2 in schematic diagram 200, a second user 104-2 may interact with input features of second communication device 102-2 in accordance with a first communication modality 106-1 and may interact with output features of second communication device 102-2 in accordance with a second communication modality 106-2. For instance, if first communication modality 106-1 comprises voice interaction, second communication modality 106-2 may comprise textual interaction. In such an instance, first user 104-1 may interact with first communication device 102-1 using voice (e.g., for both input and output) for a voice call initiated at first communication device 102-1, and second user 104-2 may interact with second communication device 102-2 using voice with respect to input features of second communication device 102-2 (e.g., second user 104-2 may speak into a microphone to input vocal sounds). However, with respect to output features of second communication device 102-2, second user 104-2 may interact with second communication device 102-2 using text. Second communication device 102-2 may, for example, display text on a screen (e.g., a LCD or LED screen) or a projection surface for the data that corresponds to vocal input from first user 104-1 at first communication device 102-1. To provide a textual version for display of voice input data, voice data may be converted to text data (e.g., at a converter).

For certain example embodiments, communication data (e.g., video data, voice data, text data, a combination thereof, etc.) may be converted from corresponding to one type of communication modality 106 to corresponding to another type of communication modality 106 by at least one converter 202. For certain example implementations, a converter 202 may perform a conversion of a correspondence with one communication modality 106 to a correspondence with another communication modality 106. By way of example but not limitation, a converter 202 may perform a conversion (e.g., of signals) from a correspondence with a first communication modality 106-1 to a correspondence with a second communication modality 106-2, may perform a conversion (e.g., of signals) from a correspondence with a second communication modality 106-2 to a correspondence with a first communication modality 106-1, some combination thereof, and so forth. By way of example only, a converter 202 may convert voice data to text data, text data to video data, text data to voice data, voice data to video data, any combination thereof, and so forth. A given multi-modality communication may be subject to one or more conversions by one or more converters 202.

For certain example embodiments, a device may include (e.g., comprise at least a portion of, have access to, implement, realize, execute, a combination thereof, etc.) at least one converter 202. As shown in schematic diagram 200, but by way of example only, a first communication device 102-1 may include a converter 202a, a second communication device 102-2 may include a converter 202b, or a network communication device 110 may include a converter 202c. Additional or alternative implementations are described herein. One or more converters 202 may be employed in different communication path or conversion scenarios.

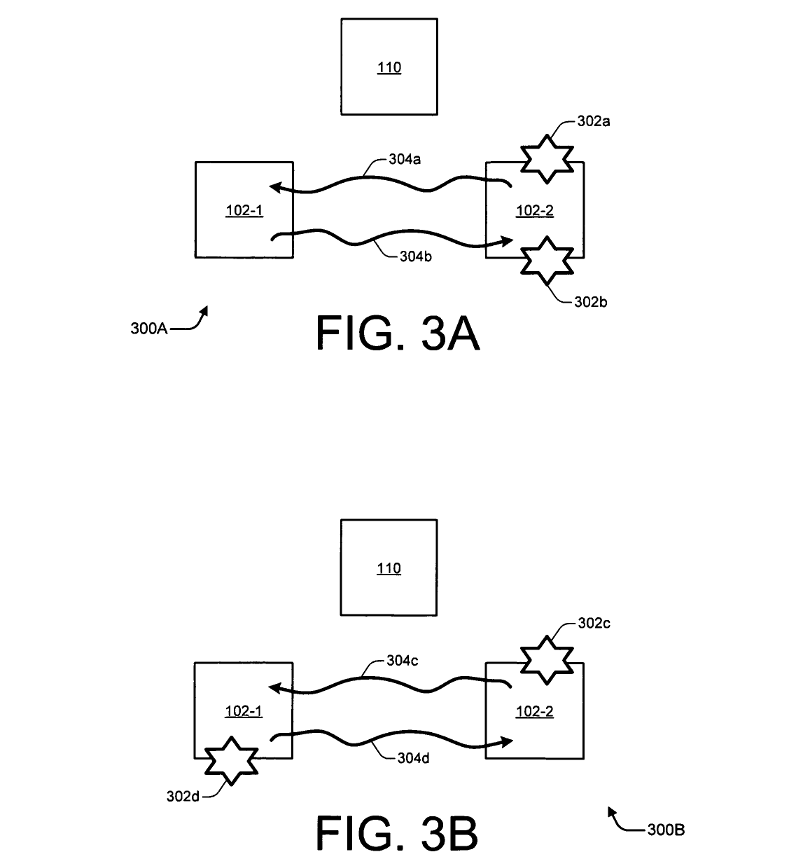

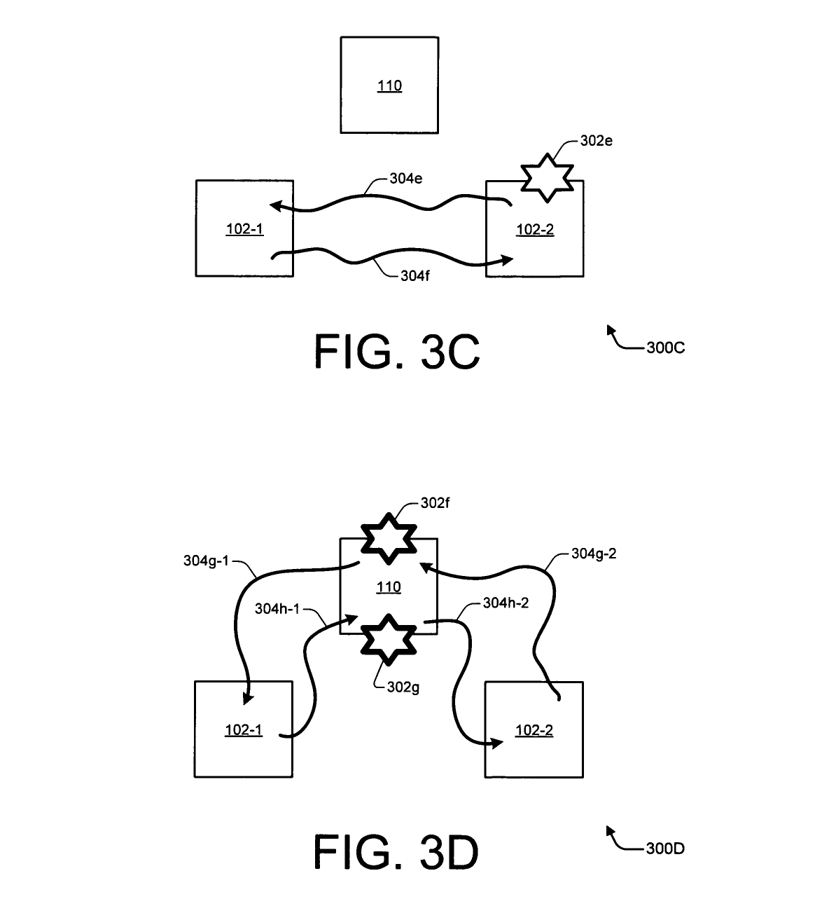

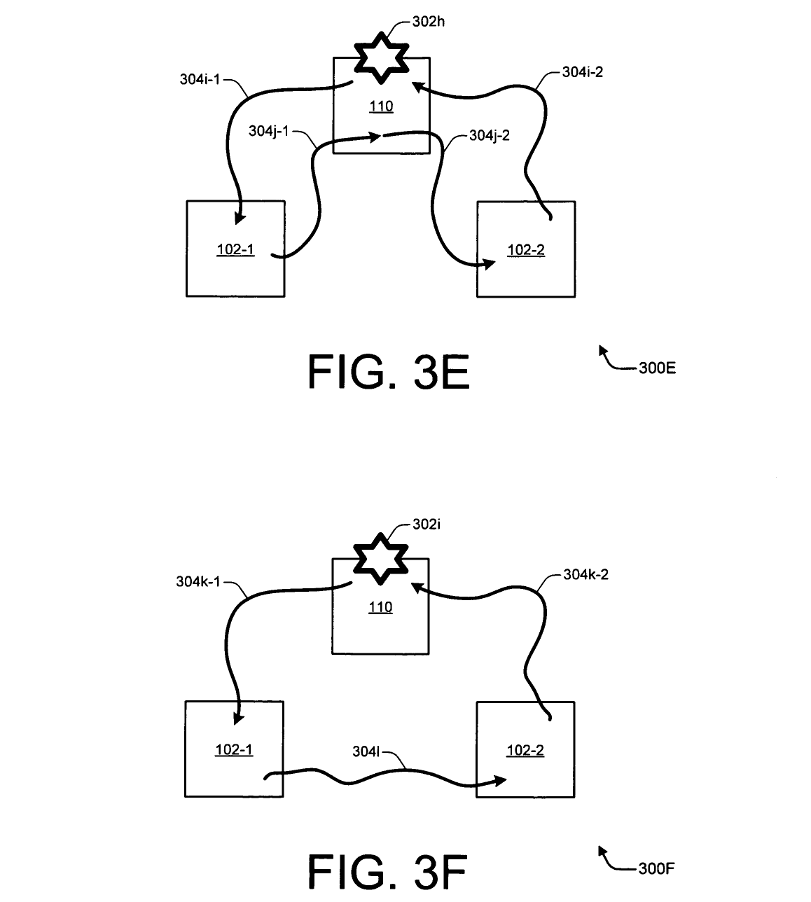

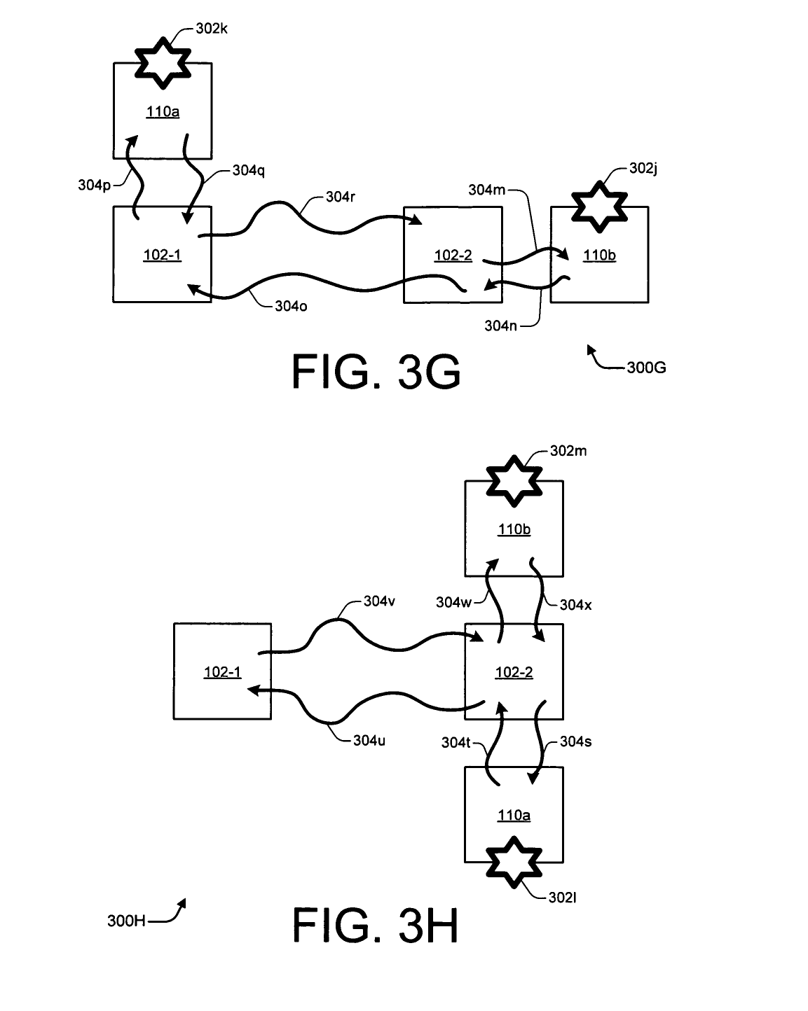

FIGS. 3A-3H are schematic diagrams illustrating different communication path or conversion scenarios 300A-300H for different example communications in accordance with certain example embodiments. As illustrated, each schematic diagram includes at least one conversion 302 or at least one communication path 304. By way of example but not limitation, a conversion 302 may comprise a conversion of data from corresponding to one communication modality to corresponding to another communication modality. By way of example but not limitation, a communication path 304 may comprise a path in which one or more signals (e.g., one or more signals 206) that include data (e.g., text data, voice data, video data, a combination thereof, etc.) traverse between two or more devices via one or more channels 108 (e.g., of FIGS. 1 and 2). Although not explicitly illustrated in FIGS. 3A-3H for the sake of visual clarity, a first user 104-1, a second user 104-2, a first communication modality 106-1, and a second communication modality 106-2 (e.g., each of FIGS. 1 and 2) are referred to herein below with regard to one or more of example scenarios 300A-300H.

For certain example embodiments, with regard to example scenario 300A of FIG. 3A, a conversion 302a or a conversion 302b may be performed at a second communication device 102-2. For certain example implementations, a first user 104-1 may interact with a first communication device 102-1 in accordance with a first communication modality 106-1, or a second user 104-2 may interact with second communication device 102-2 in accordance with a second communication modality 106-2. Second user 104-2 may provide user input interaction (e.g., video, voice, text, a combination thereof, etc.) at second communication device 102-2 in accordance with second communication modality 106-2. Data corresponding to second communication modality 106-2 may be converted to data corresponding to first communication modality 106-1 via conversion 302a. Data corresponding to first communication modality 106-1 may be transmitted from second communication device 102-2 or received at first communication device 102-1 via communication path 304a.

For certain example implementations, first communication device 102-1 may present data corresponding to first communication modality 106-1 to first user 104-1 as user output. First communication device 102-1 may accept user input to acquire data corresponding to first communication modality 106-1. First communication device 102-1 may transmit or second communication device 102-2 may receive data corresponding to first communication modality 106-1 via communication path 304b. At conversion 302b, data corresponding to first communication modality 106-1 may be converted to data corresponding to second communication modality 106-2. Second communication device 102-2 may present data corresponding to second communication modality 106-2 as user output to second user 104-2. By way of example only, first communication modality 106-1 may comprise voice interaction, and second communication modality 106-2 may comprise text interaction. With conversion 302a or conversion 302b, first user 104-1 may interact with first communication device 102-1 via voice, and second user 104-2 may interact with second communication device 102-2 via text.

For certain example embodiments, with regard to example scenario 300B of FIG. 3B, a conversion 302c may be performed at a second communication device 102-2, or a conversion 302d may be performed at a first communication device 102-1. For certain example implementations, a first user 104-1 may interact with a first communication device 102-1 in accordance with a first communication modality 106-1, or a second user 104-2 may interact with second communication device 102-2 in accordance with a second communication modality 106-2. Second user 104-2 may provide user input interaction at second communication device 102-2 in accordance with second communication modality 106-2. Data corresponding to second communication modality 106-2 may be converted to data corresponding to first communication modality 106-1 via conversion 302c. Data corresponding to first communication modality 106-1 may be transmitted from second communication device 102-2 or received at first communication device 102-1 via communication path 304c.

For certain example implementations, first communication device 102-1 may present data corresponding to first communication modality 106-1 to first user 104-1 as user output. First communication device 102-1 may accept user input to acquire data corresponding to first communication modality 106-1. At conversion 302d, data corresponding to first communication modality 106-1 may be converted to data corresponding to second communication modality 106-2. First communication device 102-1 may transmit or second communication device 102-2 may receive data corresponding to second communication modality 106-2 via communication path 304d. Second communication device 102-2 may present data corresponding to second communication modality 106-2 as user output to second user 104-2. By way of example only, first communication modality 106-1 may comprise text interaction, and second communication modality 106-2 may comprise voice interaction. With conversion 302c or conversion 302d, first user 104-1 may interact with first communication device 102-1 via text, and second user 104-2 may interact with second communication device 102-2 via voice, with conversions 302c and 302d being performed prior to transmission on both sides of a communication or at a device that receives user input data that is to be converted. A given communication device 102 may have expertise at converting user input data from a frequent user of the given communication device 102 (e.g., by using recorded sound samples—for conversion of text to voice, vocal training samples—for converting voice to text, a combination thereof, etc.). Alternatively, conversion 302c or conversion 302d may be performed on received data after transmission on one side or on two sides of a communication.

For certain example embodiments, with regard to example scenario 300C of FIG. 3C, a conversion 302e may be performed at a second communication device 102-2. For certain example implementations, a first user 104-1 may interact with a first communication device 102-1 in accordance with a first communication modality 106-1, or a second user 104-2 may interact with second communication device 102-2 in accordance with a second communication modality 106-2 for user input interaction and in accordance with first communication modality 106-1 for user output interaction. Second user 104-2 may provide user input interaction at second communication device 102-2 in accordance with second communication modality 106-2. Data corresponding to second communication modality 106-2 may be converted to data corresponding to first communication modality 106-1 via conversion 302e. Data corresponding to first communication modality 106-1 may be transmitted from second communication device 102-2 or received at first communication device 102-1 via communication path 304e.

For certain example implementations, first communication device 102-1 may present data corresponding to first communication modality 106-1 to first user 104-1 as user output. First communication device 102-1 may accept user input to acquire data corresponding to first communication modality 106-1. First communication device 102-1 may transmit or second communication device 102-2 may receive data corresponding to first communication modality 106-1 via communication path 304f. Second communication device 102-2 may present data corresponding to first communication modality 106-1 as user output to second user 104-2. By way of example only, first communication modality 106-1 may comprise voice interaction, and second communication modality 106-2 may comprise text interaction. With conversion 302e, first user 104-1 may interact with first communication device 102-1 via voice, and second user 104-2 may interact with second communication device 102-2 via voice for user output interaction (e.g., may listen to sounds at second communication device 102-2 as produced by first user 104-1 at first communication device 102-1) and via text for user input interaction (e.g., may type text into second communication device 102-2). Conversion 302e may convert input text data into converted voice data for transmission via communication path 304e.

Although not explicitly shown in FIGS. 3A-3C, a communication path between e.g. first communication device 102-1 and second communication device 102-2 may traverse one or more network communication devices. However, for example scenarios 300A-300C, conversion(s) 302 are performed at first communication device 102-1 or second communication device 102-2. In contrast, for example scenarios 300D-300F of FIGS. 3D-3F, at least one conversion 302 is performed at a network communication device 110. If a communication path 304 is “naturally” traversing a network communication device 110 (e.g., if a communication path 304 is to traverse a network communication device 110 regardless of whether a multi-modality-communication-related feature is to be facilitated by network communication device 110), then network communication device 110 may intercept communication data flowing along communication path 304. Communication data may be intercepted by a network communication device 110 on its own accord or based on its own instructions, in response to a request by a first communication device 102-1, in response to a request by a second communication device 102-2, in response to a request from a third party, in response to one or more stored settings, in response to an indication in a communication initiation or setup message, any combination thereof, and so forth. By way of example but not limitation, a network communication device 110 that comprises a telecommunication node, an internet node facilitating a voice over internet protocol (VoIP) communication, a combination thereof, etc. may be capable of intercepting a communication flow along a communication path 304 and implementing a multi-modality-communication-related-feature (e.g., a communication modality conversion) for an intercepted communication flow. Additionally or alternatively, a communication path 304 may be redirected so as to traverse a network communication device 110 that is capable of implementing a multi-modality-communication-related-feature (e.g., a communication modality conversion) for a redirected communication flow. A communication path may be redirected in response to a command by a first communication device 102-1, in response to a command by a second communication device 102-2, in response to a request from a third party, any combination thereof, and so forth.

For certain example embodiments, with regard to example scenario 300D of FIG. 3D, a conversion 302f or a conversion 302g may be performed at a network communication device 110. For certain example implementations, a first user 104-1 may interact with a first communication device 102-1 in accordance with a first communication modality 106-1, or a second user 104-2 may interact with a second communication device 102-2 in accordance with a second communication modality 106-2. Second user 104-2 may provide user input interaction at second communication device 102-2 in accordance with second communication modality 106-2. Data corresponding to second communication modality 106-2 may be transmitted from second communication device 102-2 or received at network communication device 110 via communication path 304g-2. Data corresponding to second communication modality 106-2 may be converted to data corresponding to first communication modality 106-1 via conversion 302f. Data corresponding to first communication modality 106-1 may be transmitted from network communication device 110 or received at first communication device 102-1 via communication path 304g-1.

For certain example implementations, first communication device 102-1 may present data corresponding to first communication modality 106-1 to first user 104-1 as user output. First communication device 102-1 may accept user input to acquire data corresponding to first communication modality 106-1. First communication device 102-1 may transmit or network communication device 110 may receive data corresponding to first communication modality 106-1 via communication path 304h-1. Data corresponding to first communication modality 106-1 may be converted to data corresponding to second communication modality 106-2 via conversion 302g. Data corresponding to second communication modality 106-2 may be transmitted from network communication device 110 or received at second communication device 102-2 via communication path 304h-2. Second communication device 102-2 may present data corresponding to second communication modality 106-2 as user output to second user 104-2. By way of example only, first communication modality 106-1 may comprise video interaction, and second communication modality 106-2 may comprise voice interaction. With conversion 302f and conversion 302g at network communication device 110, first user 104-1 may interact with first communication device 102-1 via video, and second user 104-2 may interact with second communication device 102-2 via voice. It should be understood that conversion 302f may not be a reciprocal or inverse process of conversion 302g (or vice versa); additionally or alternatively, data corresponding to first communication modality 106-1 may be converted to data corresponding to a third communication modality via a conversion 302g, for example if user output interaction at second communication device 102-2 corresponds to a third communication modality. Additionally or alternatively, first communication device 102-1 or second communication device 102-2 may perform at least one conversion (e.g., a conversion 302f or 302g in lieu of two conversions being performed by network communication device 110 as shown in example scenario 300D).

For certain example embodiments, with regard to example scenario 300E of FIG. 3E, a conversion 302h may be performed at a network communication device 110. For certain example implementations, a first user 104-1 may interact with a first communication device 102-1 in accordance with a first communication modality 106-1 for user output interaction and in accordance with a second communication modality 106-2 for user input interaction, or a second user 104-2 may interact with second communication device 102-2 in accordance with a second communication modality 106-2 for user input interaction and for user output interaction. Second user 104-2 may provide user input interaction at second communication device 102-2 in accordance with second communication modality 106-2. Data corresponding to second communication modality 106-2 may be transmitted from second communication device 102-2 or received at network communication device 110 via communication path 304i-2. Data corresponding to second communication modality 106-2 may be converted to data corresponding to first communication modality 106-1 via conversion 302h. Data corresponding to first communication modality 106-1 may be transmitted from network communication device 110 or received at first communication device 102-1 via communication path 304i-1.

For certain example implementations, first communication device 102-1 may present data corresponding to first communication modality 106-1 to first user 104-1 as user output. First communication device 102-1 may accept user input to acquire data corresponding to second communication modality 106-2. First communication device 102-1 may transmit or network communication device 110 may receive data corresponding to second communication modality 106-2 via communication path 304j-1. Data corresponding to second communication modality 106-2 may be transmitted from network communication device 110 or received at second communication device 102-2 via communication path 304j-2. Second communication device 102-2 may present data corresponding to second communication modality 106-2 as user output to second user 104-2. By way of example only, first communication modality 106-1 may comprise voice interaction, and second communication modality 106-2 may comprise video interaction. With conversion 302h, first user 104-1 may interact with first communication device 102-1 via voice for user output interaction and via video for user input interaction, and second user 104-2 may interact with second communication device 102-2 via video for user input and user output. As shown for an example scenario 300E, a communication flow may traverse a network communication device 110 without a conversion being applied thereto.

For certain example embodiments, with regard to example scenario 300F of FIG. 3F, a conversion 302i may be performed at a network communication device 110. For certain example implementations, a first user 104-1 may interact with a first communication device 102-1 in accordance with a first communication modality 106-1 for user input interaction and for user output interaction, or a second user 104-2 may interact with second communication device 102-2 in accordance with a second communication modality 106-2 for user input interaction and in accordance with first communication modality 106-1 for user output interaction. Second user 104-2 may provide user input interaction at second communication device 102-2 in accordance with second communication modality 106-2. Data corresponding to second communication modality 106-2 may be transmitted from second communication device 102-2 or received at network communication device 110 via communication path 304k-2. Data corresponding to second communication modality 106-2 may be converted to data corresponding to first communication modality 106-1 via conversion 302i. Data corresponding to first communication modality 106-1 may be transmitted from network communication device 110 or received at first communication device 102-1 via communication path 304k-1.

For certain example implementations, first communication device 102-1 may present data corresponding to first communication modality 106-1 to first user 104-1 as user output. First communication device 102-1 may accept user input to acquire data corresponding to first communication modality 106-1. First communication device 102-1 may transmit or second communication device 102-2 may receive data corresponding to first communication modality 106-1 via communication path 304l. Second communication device 102-2 may present data corresponding to first communication modality 106-1 as user output to second user 104-2. As shown by communication path 304l for an example scenario 300F, and in contrast with example scenario 300E (of FIG. 3E), a communication may omit traversal of a network communication device 110 for one part of a communication flow even if that network communication device 110 is performing a conversion for another part of the communication flow.

FIGS. 3A-3C illustrate example scenarios 300A-300C in which conversion is performed at a first communication device 102-1 or a second communication device 102-2. A communication device 102 may effectuate a conversion of data from corresponding to one communication modality to corresponding to another communication modality using an on-board converter (e.g., a converter 202). Additionally or alternatively, a communication device 102 may effectuate a conversion of data by causing (e.g., requesting, commanding, notifying, a combination thereof, etc.) a network communication device 110 to perform a conversion. FIGS. 3D-3F illustrate example scenarios 300D-300F in which conversion is performed at a network communication device 110 along a communication path between a first communication device 102-1 and a second communication device 102-2. In contrast, FIGS. 3G and 3H illustrate example scenarios 300G and 300H in which conversion is performed at a network communication device 110 by “farming out” a conversion process. For example, a first communication device 102-1 or a second communication device 102-2 may send data in one communication modality to a network communication device 110 and may receive in return converted data in another communication modality from the network communication device 110.

It should be understood, however, that described scenarios 300A-300H are not mutually exclusive; instead, they may be combined fully or partially or otherwise modified without departing from claimed subject matter. By way of example only, a second communication device 102-2 may perform one conversion itself and farm out another conversion to a network communication device 110. Additionally or alternatively, a network communication device 110 may perform a conversion via an interception of a communication flow, and a first communication device 102-1 may perform another conversion for the communication flow. Additionally or alternatively, a network communication device 110 may itself farm out one, two, or more conversions to other network communication device(s). Moreover, if two or more conversions are farmed out to different network communication devices, the different network communication devices may be associated (e.g., owned by, managed by, operated by, controlled by, a combination thereof, etc.) different entities. Other combinations or modifications of described scenarios may alternatively be implemented.

For certain example embodiments, with regard to example scenario 300G of FIG. 3G, a conversion 302j may be performed at a network communication device 110b, or a conversion 302k may be performed at a network communication device 110a. For certain example implementations, a first user 104-1 may interact with a first communication device 102-1 in accordance with a first communication modality 106-1, or a second user 104-2 may interact with second communication device 102-2 in accordance with a second communication modality 106-2. Second user 104-2 may provide user input interaction at second communication device 102-2 in accordance with second communication modality 106-2. Data corresponding to second communication modality 106-2 may be transmitted from second communication device 102-2 or received at network communication device 110b via communication path 304m. Data corresponding to second communication modality 106-2 may be converted to data corresponding to first communication modality 106-1 via conversion 302j. Data corresponding to first communication modality 106-1 may be transmitted from network communication device 110b or received at second communication device 102-2 via communication path 304n. Data corresponding to first communication modality 106-1 may be transmitted from second communication device 102-2 or received at first communication device 102-1 via communication path 304o.

For certain example implementations, first communication device 102-1 may present data corresponding to first communication modality 106-1 to first user 104-1 as user output. First communication device 102-1 may accept user input to acquire data corresponding to first communication modality 106-1. Data corresponding to first communication modality 106-1 may be transmitted from first communication device 102-1 or received at network communication device 110a via communication path 304p. At conversion 302k, data corresponding to first communication modality 106-1 may be converted to data corresponding to second communication modality 106-2. Data corresponding to second communication modality 106-2 may be transmitted from network communication device 110a or received at first communication device 102-1 via communication path 304q. First communication device 102-1 may transmit or second communication device 102-2 may receive data corresponding to second communication modality 106-2 via communication path 304r. Second communication device 102-2 may present data corresponding to second communication modality 106-2 as user output to second user 104-2. Although conversions 302j and 302k are described as being performed after receiving user input but prior to transmission to another communication device 102, one or more conversions may additionally or alternatively be performed after receiving a transmission of data corresponding to one communication modality but prior to presentation of converted data corresponding to another communication modality. Additionally or alternatively, first communication device 102-1 and second communication device 102-2 may farm out conversion to a single network communication device 110. A network communication device 110a or a network communication device 110b may be associated with a same entity or with different entities.

For certain example embodiments, with regard to example scenario 300H of FIG. 3H, a conversion 302l may be performed at a network communication device 110a, or a conversion 302m may be performed at a network communication device 110b. For certain example implementations, a first user 104-1 may interact with a first communication device 102-1 in accordance with a first communication modality 106-1, or a second user 104-2 may interact with second communication device 102-2 in accordance with a second communication modality 106-2. Second communication device 102-2 may accept user input interaction from second user 104-2 in accordance with second communication modality 106-2. Data corresponding to second communication modality 106-2 may be transmitted from second communication device 102-2 or received at network communication device 110a via communication path 304s. Data corresponding to second communication modality 106-2 may be converted to data corresponding to first communication modality 106-1 via conversion 302l. Data corresponding to first communication modality 106-1 may be transmitted from network communication device 110a or received at second communication device 102-2 via communication path 304t. Data corresponding to first communication modality 106-1 may be transmitted from second communication device 102-2 or received at first communication device 102-1 via communication path 304u.

For certain example implementations, first communication device 102-1 may present data corresponding to first communication modality 106-1 to first user 104-1 as user output. First communication device 102-1 may accept user input to acquire data corresponding to first communication modality 106-1. Data corresponding to first communication modality 106-1 may be transmitted from first communication device 102-1 or received at second communication device 102-2 via communication path 304v. Data corresponding to first communication modality 106-1 may be transmitted from second communication device 102-2 or received at network communication device 110b via communication path 304w. At conversion 302m, data corresponding to first communication modality 106-1 may be converted to data corresponding to second communication modality 106-2. Network communication device 110b may transmit or second communication device 102-2 may receive data corresponding to second communication modality 106-2 via communication path 304x. Second communication device 102-2 may present data corresponding to second communication modality 106-2 as user output to second user 104-2. Although conversions 302l and 302m are described as being performed at a certain point along a communication flow, conversions may additionally or alternatively be performed at different points along a communication flow. Additionally or alternatively, second communication device 102-2 may farm out conversions to a single network communication device 110.

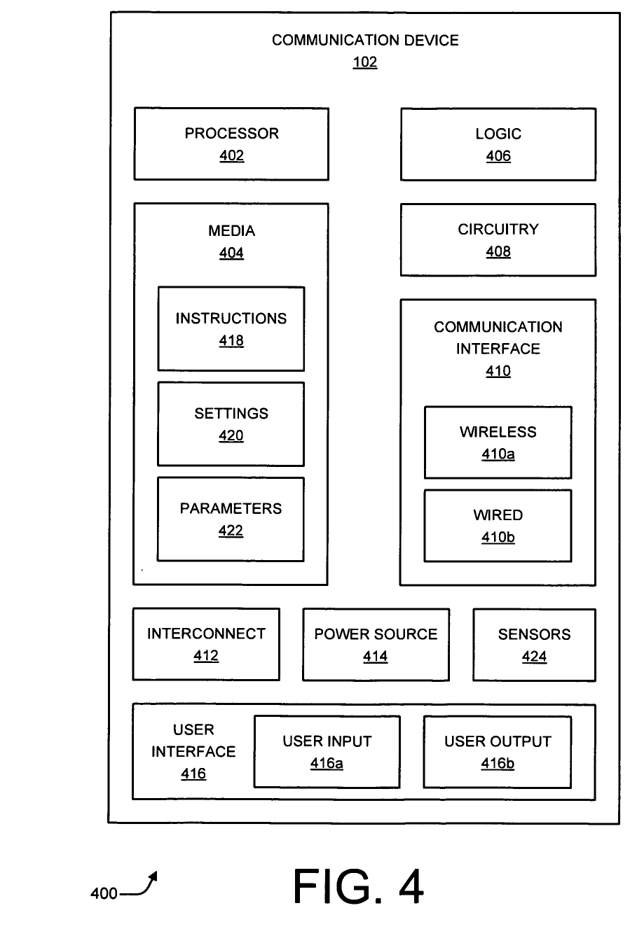

FIG. 4 is a schematic diagram 400 of an example communication device including one or more example components in accordance with certain example embodiments. As shown in FIG. 4, a communication device 102 may include one or more components such as: at least one processor 402, one or more media 404, logic 406, circuitry 408, at least one communication interface 410, at least one interconnect 412, at least one power source 414, or at least one user interface 416, one or more sensors 424, any combination thereof, and so forth. Furthermore, as shown in schematic diagram 400, one or more media 404 may comprise one or more instructions 418, one or more settings 420, one or more parameters 422, some combination thereof, and so forth; communication interface 410 may comprise at least one wireless communication interface 410a, at least one wired communication interface 410b, some combination thereof, and so forth; or user interface 416 may comprise at least one user input interface 416a, at least one user output interface 416b, some combination thereof, and so forth. However, a communication device 102 may alternatively include more, fewer, or different components from those that are illustrated without deviating from claimed subject matter.

For certain example embodiments, a communication device 102 may include or comprise at least one electronic device. Communication device 102 may comprise, for example, a computing platform or any electronic device having at least one processor or memory. Processor 402 may comprise, by way of example but not limitation, any one or more of a general-purpose processor, a specific-purpose processor, a digital signal processor (DSP), a processing unit, a combination thereof, and so forth. A processing unit may be implemented, for example, with one or more application specific integrated circuits (ASICs), DSPs, digital signal processing devices (DSPDs), programmable logic devices (PLDs), field programmable gate arrays (FPGAs), processors generally, processing cores, discrete/fixed logic circuitry, controllers, micro-controllers, microprocessors, a combination thereof, and so forth. Media 404 may bear, store, contain, provide access to, a combination thereof, etc. instructions 418, which may be executable by processor 402. Instructions 418 may comprise, by way of example but not limitation, a program, a module, an application or app (e.g., that is native, that runs in a browser, that runs within a virtual machine, a combination thereof, etc.), an operating system, etc. or portion thereof; operational data structures; processor-executable instructions; code; or any combination thereof; and so forth. Media 404 may comprise, by way of example but not limitation, processor-accessible or non-transitory media that is capable of bearing instructions, settings, parameters, a combination thereof, and so forth.

For certain example embodiments, execution of instructions 418 by one or more processors 402 may transform communication device 102 into a special-purpose computing device, apparatus, platform, or any combination thereof, etc. Instructions 418 may correspond to, for example, instructions that are capable of realizing at least a portion of one or more flow diagrams methods, processes, operations, functionality, technology, or mechanisms, etc. that are described herein or illustrated in the accompanying drawings. Settings 420 may comprise, by way of example but not limitation, one or more indicators that may be established by a user or other entity, one or more indicators that may determine at least partly how a communication device 102 is to operate or respond to situations, one or more indicators or other values that may be used to realize flow diagrams, methods, processes, operations, functionality, technology, or mechanisms, etc. that are described herein or illustrated in the accompanying drawings. Parameters 422 may comprise, by way of example but not limitation, one or more indicators that may be established by a user or other entity, one or more indicators that may be determined by a communication device 102, one or more values that may be determined by a user or other entity, one or more values that may be detected by communication device 102, one or more values that may be received from another device that detected them, one or more values that may be determined by communication device 102 or by another device, one or more indicators or values that may determine at least partly how a communication device 102 is to operate or respond to situations, one or more indicators or values that may be used to realize flow diagrams, methods, processes, operations, functionality, technology, or mechanisms, etc. that are described herein or illustrated in the accompanying drawings.

For certain example embodiments, logic 406 may comprise hardware, software, firmware, discrete/fixed logic circuitry, any combination thereof, etc. that is capable of performing or facilitating performance of methods, processes, operations, functionality, technology, or mechanisms, etc. that are described herein or illustrated in the accompanying drawings. Circuitry 408 may comprise hardware, software, firmware, discrete/fixed logic circuitry, any combination thereof, etc. that is capable of performing or facilitating performance of methods, processes, operations, functionality, technology, or mechanisms, etc. that are described herein or illustrated in the accompanying drawings, wherein circuitry 408 comprises at least one physical or hardware component or aspect.

For certain example embodiments, one or more communication interfaces 410 may provide one or more interfaces between communication device 102 and another device or a person/operator. With respect to a person/operator, a communication interface 410 may include, by way of example but not limitation, a screen, a speaker, a keyboard or keys, or other person-device input/output features. A wireless communication interface 410a or a wired communication interface 410b may also or alternatively include, by way of example but not limitation, a transceiver (e.g., transmitter or receiver), a radio, an antenna, a wired interface connector or other similar apparatus (e.g., a universal serial bus (USB) connector, a proprietary connector, a Thunderbolt® or Light Peak® connector, a combination thereof, etc.), a physical or logical network adapter or port, or any combination thereof, etc. to communicate wireless signals or wired signals via one or more wireless communication links or wired communication links, respectively. Communications with at least one communication interface 410 may enable transmitting, receiving, or initiating of transmissions, just to name a few examples.

For certain example embodiments, at least one interconnect 412 may enable signal communication between or among components of communication device 102. Interconnect 412 may comprise, by way of example but not limitation, one or more buses, channels, switching fabrics, or combinations thereof, and so forth. Although not explicitly illustrated in FIG. 4, one or more components of communication device 102 may be coupled to interconnect 412 via a discrete or integrated interface. By way of example only, one or more interfaces may couple a communication interface 410 or a processor 402 to at least one interconnect 412. At least one power source 414 may provide power to components of communication device 102. Power source 414 may comprise, by way of example but not limitation, a battery, a power connector, a solar power source or charger, a mechanical power source or charger, a fuel source, any combination thereof, and so forth.

For certain example embodiments, at least one sensor 424 may sense, produce, or otherwise provide at least one sensor value. Sensors 424 may include, by way of example only, a camera, a microphone, an accelerometer, a thermometer, a satellite positioning system (SPS) sensor, a barometer, a humidity sensor, a compass, a gyroscope, a magnetometer, a pressure sensor, an oscillator, a light sensor, an inertial measurement unit (IMU), a tactile sensor, a flexibility sensor, multiple ones thereof, any combination thereof, and so forth. Values provided by at least one sensor 424 may comprise, by way of example but not limitation, an image, a sound recording, an acceleration value, a temperature, SPS coordinates, a barometric pressure, a humidity level, a compass direction, a gyroscopic value, a magnetic reading, a pressure value, an oscillation value, an ambient light reading, inertial readings, touch detections, flex detections, any combination thereof, and so forth.

For certain example embodiments, a user interface 416 may enable one or more users to interact with communication device 102. Interactions between a user and device may relate, by way of example but not limitation, to touch/tactile/feeling/haptic sensory (e.g., a user may shake, bend, twist, or move a device which may be detected by a gyroscope, an accelerometer, a compass, a combination thereof, etc; a user may press a button, slide a switch, rotate a knob, etc.; a user may touch a touch-sensitive screen; a device may vibrate; some combination thereof; etc.), to sound/hearing/speech sensory (e.g., a user may speak into a microphone, a device may generate sounds via a speaker, some combination thereof, etc.), to sights/vision sensory (e.g., a device may activate one or more lights, modify a display screen, a combination thereof, etc.), any combination thereof, and so forth.

For certain example embodiments, a user interface 416 may comprise a user input interface 416a, a user output interface 416b, a combination thereof, and so forth. A user input interface 416a may comprise, by way of example but not limitation, a microphone, a button, a switch, a dial, a knob, a wheel, a trackball, a key, a keypad, a keyboard, a touch-sensitive screen, a touch-sensitive surface, a camera, a gyroscope, an accelerometer, a compass, any combination thereof, and so forth. A user output interface 416b may comprise, by way of example but not limitation, a speaker, a screen (e.g., with or without touch-sensitivity), a vibrating haptic feature, any combination thereof, and so forth. Certain user interfaces 416 may enable both user input and user output. For example, a touch-sensitive screen may be capable of providing user output and accepting user input. Additionally or alternatively, a user interface component (e.g., that may be integrated with or separate from a communication device 102), such as a headset that has a microphone and a speaker, may enable both user input and user output.

It should be understood that for certain example implementations components illustrated separately in FIG. 4 are not necessarily separate or mutually exclusive. For example, a given component may provide multiple functionalities. By way of example only, a single component such as a USB connector may function as a wired communication interface 410b or a power source 414. Additionally or alternatively, a single component such as a display screen may function as a communication interface 410 with a user, as a user input interface 416a, or as a user output interface 416b. Additionally or alternatively, one or more instructions 418 may function to realize at least one setting 420 or at least one parameter 422.

It should also be understood that for certain example implementations components illustrated in schematic diagram 400 or described herein may not be integral or integrated with a communication device 102. For example, a component may be removably connected to a communication device 102, a component may be wirelessly coupled to a communication device 102, any combination thereof, and so forth. By way of example only, instructions 418 may be stored on a removable card having at least one medium 404. Additionally or alternatively, a user interface 416 (e.g., a wired or wireless headset, a screen, a video camera, a keyboard, a combination thereof, etc.) may be coupled to communication device 102 wirelessly or by wire. For instance, a user may provide user input or accept user output corresponding to a voice communication modality to or from, respectively, a communication device 102 via a wireless (e.g., a Bluetooth®) headset that may comprise a user interface 416.

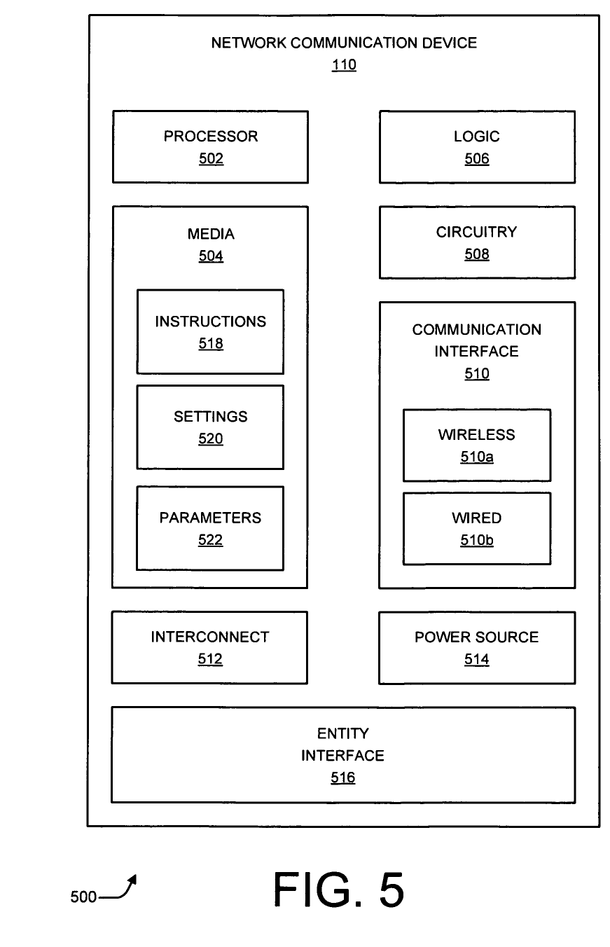

FIG. 5 is a schematic diagram 500 of an example network communication device including one or more example components in accordance with certain example embodiments. As shown in FIG. 5, a network communication device 110 may include one or more components such as: at least one processor 502, one or more media 504, logic 506, circuitry 508, at least one communication interface 510, at least one interconnect 512, at least one power source 514, or at least one entity interface 516, any combination thereof, and so forth. Furthermore, as shown in schematic diagram 500, one or more media 504 may comprise one or more instructions 518, one or more settings 520, one or more parameters 522, some combination thereof, and so forth; or communication interface 510 may comprise at least one wireless communication interface 510a, at least one wired communication interface 510b, some combination thereof, and so forth. However, a network communication device 110 may alternatively include more, fewer, or different components from those that are illustrated without deviating from claimed subject matter.

For certain example embodiments, a network communication device 110 may include or comprise at least one processing or computing device or machine. Network communication device 110 may comprise, for example, a computing platform or any electronic device or devices having at least one processor or memory. Processor 502 may comprise, by way of example but not limitation, any one or more of a general-purpose processor, a specific-purpose processor, a digital signal processor (DSP), a processing unit, a combination thereof, and so forth. A processing unit may be implemented, for example, with one or more application specific integrated circuits (ASICs), DSPs, digital signal processing devices (DSPDs), programmable logic devices (PLDs), field programmable gate arrays (FPGAs), processors generally, processing cores, discrete/fixed logic circuitry, controllers, micro-controllers, microprocessors, a combination thereof, and so forth. Media 504 may bear, store, contain, provide access to, a combination thereof, etc. instructions 518, which may be executable by processor 502. Instructions 518 may comprise, by way of example but not limitation, a program, a module, an application or app (e.g., that is native, that runs in a browser, that runs within a virtual machine, a combination thereof, etc.), an operating system, etc. or portion thereof; operational data structures; processor-executable instructions; code; or any combination thereof; and so forth. Media 504 may comprise, by way of example but not limitation, processor-accessible or non-transitory media that is capable of bearing instructions, settings, parameters, a combination thereof, and so forth.

For certain example embodiments, execution of instructions 518 by one or more processors 502 may transform network communication device 110 into a special-purpose computing device, apparatus, platform, or any combination thereof, etc. Instructions 518 may correspond to, for example, instructions that are capable of realizing at least a portion of one or more flow diagrams methods, processes, operations, functionality, technology, or mechanisms, etc. that are described herein or illustrated in the accompanying drawings. Settings 520 may comprise, by way of example but not limitation, one or more indicators that may be established by a user or other entity, one or more indicators that may determine at least partly how a network communication device 110 is to operate or respond to situations, one or more indicators or other values that may be used to realize flow diagrams, methods, processes, operations, functionality, technology, or mechanisms, etc. that are described herein or illustrated in the accompanying drawings. Parameters 522 may comprise, by way of example but not limitation, one or more indicators that may be established by a user or other entity, one or more indicators that may be determined by a network communication device 110, one or more values that may be determined by a user or other entity, one or more values that may be detected by a network communication device 110, one or more values that may be received from another device that detected them, one or more values that may be determined by network communication device 110 or by another device, one or more indicators or values that may determine at least partly how a network communication device 110 is to operate or respond to situations, one or more indicators or values that may be used to realize flow diagrams, methods, processes, operations, functionality, technology, or mechanisms, etc. that are described herein or illustrated in the accompanying drawings.

For certain example embodiments, logic 506 may comprise hardware, software, firmware, discrete/fixed logic circuitry, any combination thereof, etc. that is capable of performing or facilitating performance of methods, processes, operations, functionality, technology, or mechanisms, etc. that are described herein or illustrated in the accompanying drawings. Circuitry 508 may comprise hardware, software, firmware, discrete/fixed logic circuitry, any combination thereof, etc. that is capable of performing or facilitating performance of methods, processes, operations, functionality, technology, or mechanisms, etc. that are described herein or illustrated in the accompanying drawings, wherein circuitry 508 comprises at least one physical or hardware component or aspect.

For certain example embodiments, one or more communication interfaces 510 may provide one or more interfaces between network communication device 110 and another device or a person/operator/entity indirectly. A wireless communication interface 510a or a wired communication interface 510b may also or alternatively include, by way of example but not limitation, a transceiver (e.g., transmitter or receiver), a radio, an antenna, a wired interface connector or other similar apparatus (e.g., a network connector, a universal serial bus (USB) connector, a proprietary connector, a Thunderbolt® or Light Peak® connector, a combination thereof, etc.), a physical or logical network adapter or port, an internet or telecommunications backbone connector, or any combination thereof, etc. to communicate wireless signals or wired signals via one or more wireless communication links or wired communication links, respectively. Communications with at least one communication interface 510 may enable transmitting, receiving, or initiating of transmissions, just to name a few examples.

For certain example embodiments, at least one interconnect 512 may enable signal communication between or among components of network communication device 110. Interconnect 512 may comprise, by way of example but not limitation, one or more buses, channels, switching fabrics, local area networks (LANs), storage area networks (SANs), or combinations thereof, and so forth. Although not explicitly illustrated in FIG. 5, one or more components of network communication device 110 may be coupled to interconnect 512 via a discrete or integrated interface. By way of example only, one or more interfaces may couple a communication interface 510 or a processor 502 to at least one interconnect 512. At least one power source 514 may provide power to components of network communication device 110. Power source 514 may comprise, by way of example but not limitation, a power connector for accessing an electrical grid, a fuel cell, a solar power source, any combination thereof, and so forth.

For certain example embodiments, an entity interface 516 may enable one or more entities (e.g., other devices, persons, groups, a combination thereof, etc.) to provide input to or receive output from network communication device 110. Interactions between entities and a device may relate, by way of example but not limitation, to inputting instructions, commands, settings, parameters, any combination thereof, and so forth. Certain entity interfaces 516 may enable both entity input and entity output at network communication device 110 or over at least one network link.

It should be understood that for certain example implementations components illustrated separately in FIG. 5 are not necessarily separate or mutually exclusive. For example, a given component may provide multiple functionalities. By way of example only, hard-wired logic 506 may form circuitry 508. Additionally or alternatively, a single component such as connector may function as a communication interface 510 or as an entity interface 516. Additionally or alternatively, one or more instructions 518 may function to realize at least one setting 520 or at least one parameter 522.

It should also be understood that for certain example implementations components illustrated in schematic diagram 500 or described herein may not be integral or integrated with a network communication device 110. For example, a component may be removably connected to a network communication device 110, a component may be wirelessly coupled to a network communication device 110, any combination thereof, and so forth. By way of example only, instructions 518 may be stored on one medium 504, and settings 502 or parameters 522 may be stored on a different medium 504, which may comprise a part of a different server of e.g. a server farm. Additionally or alternatively, respective processor-media pairs may be physically realized on respective server blades. Multiple server blades, for instance, may be linked to realize at least one network communication device 110.

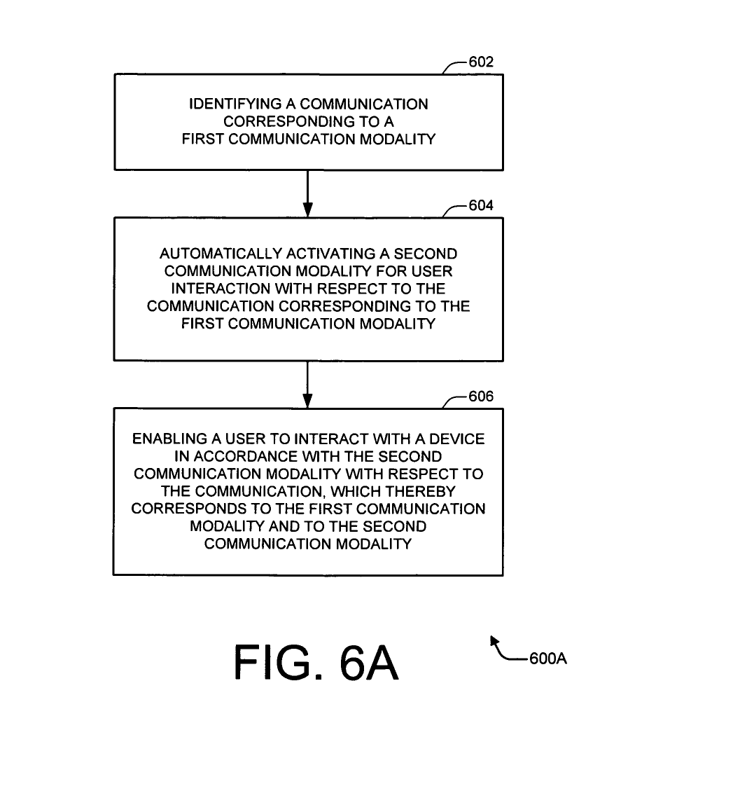

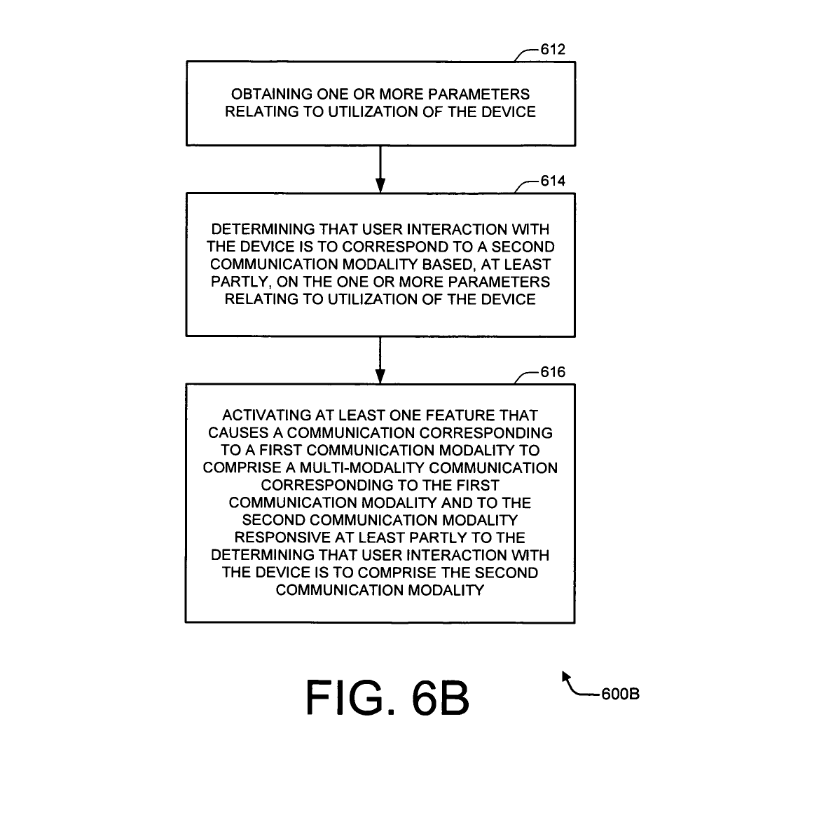

FIG. 6A is a flow diagram 600A illustrating an example method for implementing auto-activation with regard to multi-modality communication at least partially by a communication device in accordance with certain example embodiments. As illustrated, flow diagram 600A may include any of operations 602-606. Although operations 602-606 are shown or described in a particular order, it should be understood that methods may be performed in alternative manners without departing from claimed subject matter, including, but not limited to, with a different order or number of operations or with a different relationship between or among operations. Also, at least some operations of flow diagram 600A may be performed so as to be fully or partially overlapping with other operation(s). For certain example embodiments, one or more operations of flow diagram 600A may be performed by a communication device (e.g., a communication device 102).

For certain example embodiments, at operation 602, a communication device may identify a communication that corresponds to a first communication modality. For certain example implementations, an identified communication may comprise an incoming communication that is to be terminated at a communication device, may comprise an outgoing communication that is to be initiated at a communication device, any combination thereof, and so forth. By way of example but not limitation, a communication that corresponds to a voice communication modality may be identified.

For certain example embodiments, at operation 604, a communication device may automatically activate a second communication modality for user interaction at the communication device with respect to the communication that corresponds to the first communication modality. For certain example implementations, a communication device may automatically activate a second communication modality (e.g., activate a second communication modality without a contemporaneous user command to do so) for user input interaction, for user output interaction, a combination thereof, etc. with respect to an identified communication that corresponds to a first communication modality. By way of example but not limitation, a communication device may activate a textual communication modality for user input interaction or for user output interaction with respect to an identified communication that corresponds to a voice communication modality.

For certain example embodiments, at operation 606, a communication device may enable a user to interact with it in accordance with a second communication modality with respect to an identified communication that corresponds to a first communication modality, which identified communication may thereby correspond to the first communication modality and to the second communication modality. By way of example but not limitation, a communication device may enable a user to interact with it in accordance with a textual communication modality with respect to an identified communication that corresponds to a voice communication modality, which communication may thereby comprise a multi-modality communication that corresponds to a textual communication modality and a voice communication modality.

FIG. 6B is a flow diagram 600B illustrating an example method for automatically activating a feature for multi-modality communication at least partially by a communication device in accordance with certain example embodiments. As illustrated, flow diagram 600B may include any of operations 612-616. Although operations 612-616 are shown or described in a particular order, it should be understood that methods may be performed in alternative manners without departing from claimed subject matter, including, but not limited to, with a different order or number of operations or with a different relationship between or among operations. Also, at least some operations of flow diagram 600B may be performed so as to be fully or partially overlapping with other operation(s). For certain example embodiments, one or more operations of flow diagram 600B may be performed by a communication device (e.g., a communication device 102).

For certain example embodiments, at operation 612, a communication device may obtain one or more parameters relating to utilization of the device. For certain example implementations, a parameter obtainer of a communication device may retrieve parameter(s) from memory, may receive parameter(s) from another communication device, may receive parameter(s) from a network communicate device, may acquire parameter(s) via one or more sensors, any combination thereof, and so forth. By way of example but not limitation, a communication device may retrieve stored preferences, may receive a status known at or a value calculated by a network communication device, may receive an indication of a capability of or a party associated with another communication device, may ascertain an environmental parameter, any combination thereof, and so forth.

For certain example embodiments, at operation 614, a communication device may determine that user interaction with the device is to correspond to a second communication modality based, at least partly, on the one or more parameters relating to utilization of the device. For certain example implementations, a communication modality determiner of a communication device may determine that interaction by a user of the communication device is to correspond to a second communication modality based at least partially on one or more obtained parameters relating to utilization of the communication device. By way of example but not limitation, a communication modality may be determined to correspond to a textual modality even if a user or other party to a communication initiates the communication as corresponding to a voice communication modality.

For certain example embodiments, at operation 616, a communication device may activate at least one feature that causes a communication corresponding to a first communication modality to comprise a multi-modality communication corresponding to the first communication modality and to the second communication modality responsive at least partly to the determining that user interaction with the device is to comprise the second communication modality. For certain example implementations, a feature activator of a communication device may activate at least one feature that enables a user of the communication device to interact with the communication device via the second communication modality, that causes the communication device to perform at least one conversion of data to or from corresponding to the second communication modality, that causes another device to perform at least one conversion of data to or from corresponding to the second communication modality, any combination thereof, and so forth. By way of example but not limitation, a keyboard input feature and a text-to-voice conversion feature of the communication device may be activated for a communication corresponding to a voice communication modality to transform the communication into a multi-modality communication corresponding to a textual communication modality and the voice communication modality.

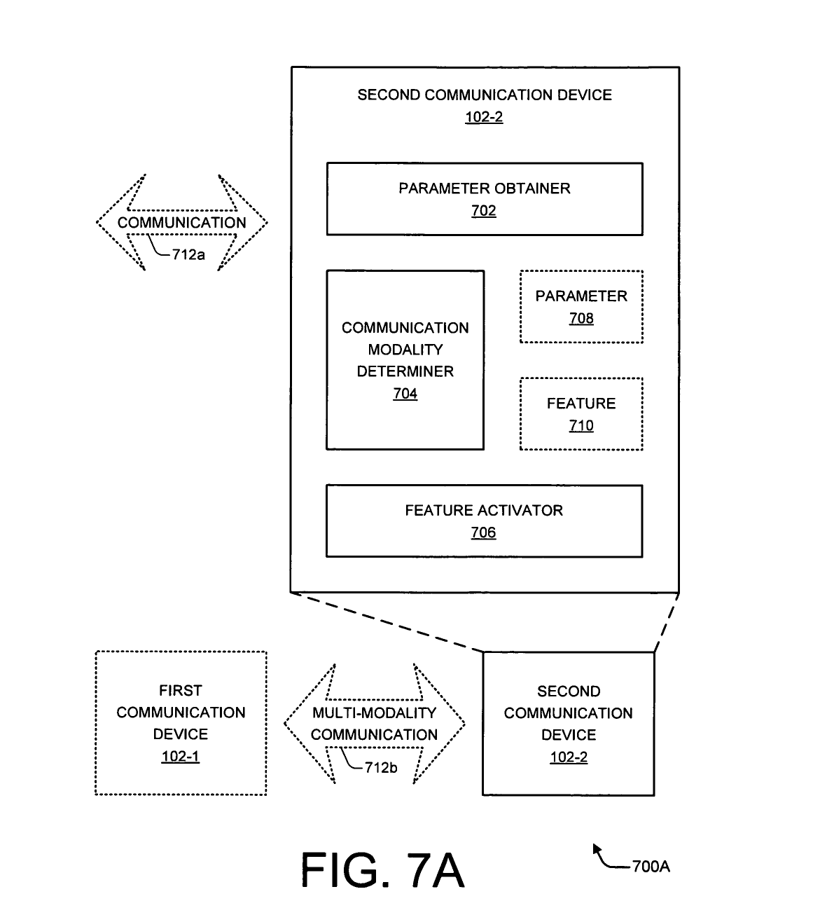

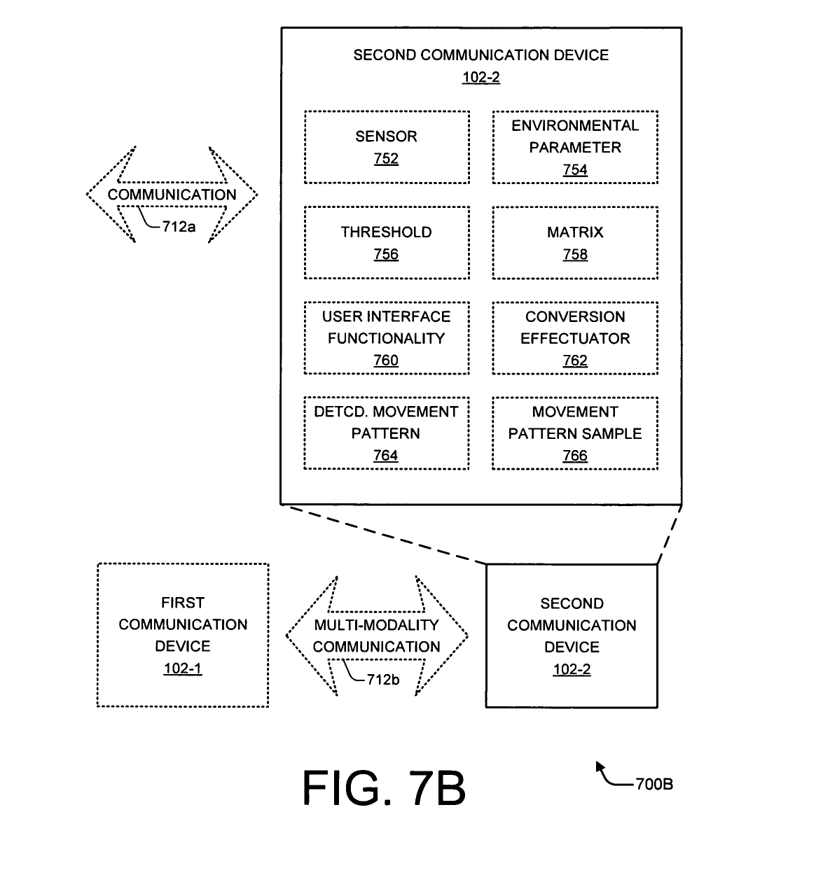

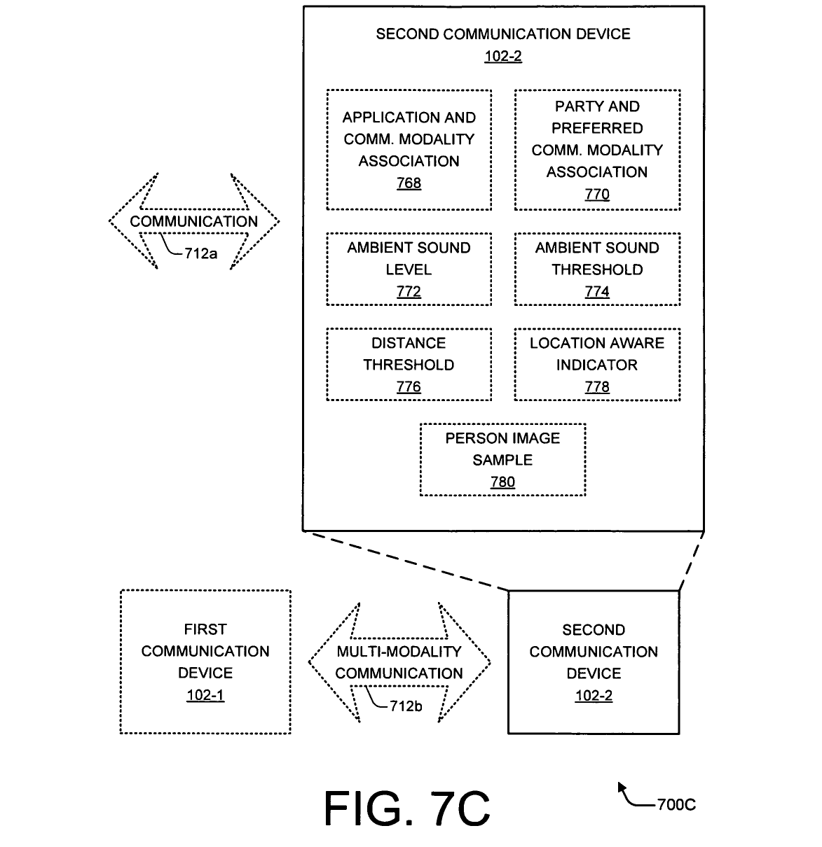

FIG. 7A is a schematic diagram 700A including an example communication device to automatically activate a feature for multi-modality communication in accordance with certain example embodiments. As shown in FIG. 7A, by way of example but not limitation, schematic diagram 700A may include at least one communication device 102 or at least one communication 712. More specifically, schematic diagram 700A may include a first communication device 102-1, a second communication device 102-2, a communication 712a, or a multi-modality communication 712b. Moreover, second communication device 102-2 may include a parameter obtainer 702, a communication modality determiner 704, a feature activator 706, one or more parameters 708, or at least one feature 710. By way of example but not limitation, parameter obtainer 702, communication modality determiner 704, or feature activator 706 may comprise one or more modules, logic, circuitry, any combination thereof, and so forth.

For certain example embodiments, a communication device 102 (e.g., a second communication device 102-2) for automatic activation of multi-modality communication may comprise: a parameter obtainer 702 for obtaining one or more parameters 708 relating to utilization of communication device 102; a communication modality determiner 704 for determining that user interaction with communication device 102 is to correspond to a second communication modality 106-2 based, at least partly, on one or more parameters 708 relating to utilization of communication device 102; or a feature activator 706 for activating at least one feature 710 that causes a communication 712a corresponding to a first communication modality 106-1 to comprise a multi-modality communication 712b corresponding to first communication modality 106-1 and to second communication modality 106-2 responsive at least partly to a determination by communication modality determiner 704 that user interaction with communication device 102 is to comprise second communication modality 106-2.

FIG. 7B is a schematic diagram 700B including a communication device that depicts example additional or alternative aspects for automatically activating a feature for multi-modality communication in accordance with certain example embodiments. As shown in FIG. 7B, by way of example but not limitation, schematic diagram 700B may include at least one communication device 102 or at least one communication 712. More specifically, schematic diagram 700B may include a first communication device 102-1, a second communication device 102-2, a communication 712a, or a multi-modality communication 712b. Moreover, second communication device 102-2 may comprise one or more example additional or alternative aspects 752-766.

For certain example embodiments, second communication device 102-2 may include any one or more of: at least one sensor 752, at least one environmental parameter 754, at least one threshold 756, at least one matrix 758, at least one user interface functionality 760, at least one conversion effectuator 762, at least one detected movement pattern 764, at least one movement pattern sample 766, any combination thereof, and so forth.

FIG. 7C is a schematic diagram 700C of a communication device that depicts example additional or alternative aspects for automatically activating a feature for multi-modality communication in accordance with certain example embodiments. As shown in FIG. 7C, by way of example but not limitation, schematic diagram 700C may include at least one communication device 102 or at least one communication 712. More specifically, schematic diagram 700C may include a first communication device 102-1, a second communication device 102-2, a communication 712a, or a multi-modality communication 712b. Moreover, second communication device 102-2 may comprise one or more example additional or alternative aspects 768-780.

For certain example embodiments, second communication device 102-2 may include any one or more of: at least one application and communication modality association 768, at least one party and preferred communication modality association 770, at least one ambient sound level 772, at least one ambient sound threshold 774, at least one distance threshold 776, at least one location-aware indicator 778, at least one person image sample 780, any combination thereof, and so forth.

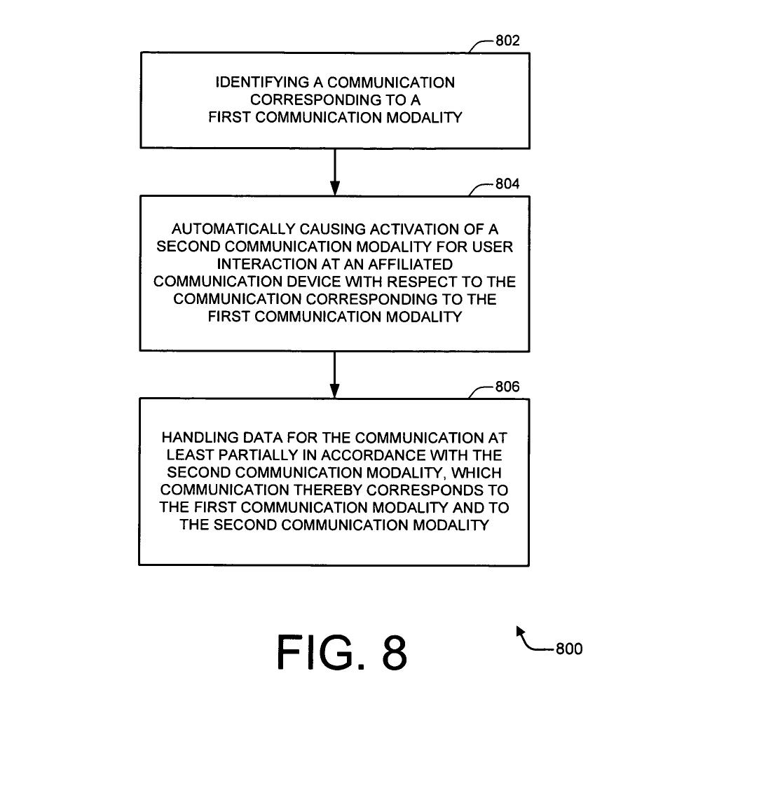

FIG. 8 is a flow diagram 800 illustrating an example method for implementing auto-activation with regard to multi-modality communication at least partially by a network communication device in accordance with certain example embodiments. As illustrated, flow diagram 800 may include any of operations 802-806. Although operations 802-806 are shown or described in a particular order, it should be understood that methods may be performed in alternative manners without departing from claimed subject matter, including, but not limited to, with a different order or number of operations or with a different relationship between or among operations. Also, at least some operations of flow diagram 800 may be performed so as to be fully or partially overlapping with other operation(s). For certain example embodiments, one or more operations of flow diagram 800 may be performed by a network communication device (e.g., a network communication device 110).

For certain example embodiments, at operation 802, a network communication device may identify a communication that corresponds to a first communication modality. For certain example implementations, an identified communication may comprise a communication that is to be terminated at a communication device with which the network communication device is affiliated, may comprise a communication that is to be initiated by a communication device with which the network communication device is affiliated, a communication that is propagating across or through the network communication device, any combination thereof, and so forth. By way of example but not limitation, a particular network communication device may be affiliated with a given communication device if there is a preexisting agreement, arrangement, expectation, any combination thereof, etc. that specifies, requests, obligates, any combination thereof, etc. the particular network communication device to provide, offer, enable, any combination thereof, etc. some functionality relating to multi-modality communication with respect to the given communication device. A particular network communication device may be affiliated with multiple communication devices that are participating in a given communication. By way of example but not limitation, a communication that corresponds to a textual communication modality may be identified.

For certain example embodiments, at operation 804, a network communication device may automatically cause activation of a second communication modality for user interaction at an affiliated communication device with respect to the communication that corresponds to the first communication modality. For certain example implementations, a network communication device may automatically cause to be activated at least one feature pertaining to a second communication modality (e.g., activate at least one feature pertaining to a second communication modality without a contemporaneous user command to do so) for user input interaction, for user output interaction, a combination thereof, etc. at an affiliated communication device with respect to an identified communication that corresponds to a first communication modality. By way of example but not limitation, a network communication device may activate at least one feature pertaining to a voice communication modality for user input interaction or for user output interaction at an affiliated communication device with respect to an identified communication that corresponds to a textual communication modality (e.g., by sending a notification of an incoming multi-modality communication, by sending data corresponding to a voice communication modality to an affiliated communication device, a combination thereof, etc.).

For certain example embodiments, at operation 806, a network communication device may handle data for an identified communication that corresponds to a first communication modality at least partially in accordance with a second communication modality, which identified communication may thereby correspond to the first communication modality and to the second communication modality. For certain example implementations, a network communication device may forward, route, convert, cause to be converted, any combination thereof, etc. data for an identified communication that corresponds to a first communication modality at least partially in accordance with a second communication modality to thereby transform the identified communication into a multi-modality communication that corresponds to the first communication modality and to the second communication modality. By way of example but not limitation, a network communication device may handle data for an identified communication that corresponds to a textual communication modality so as to enable a user to interact with the data in accordance with a voice communication modality at an affiliated communication device, which identified communication may thereby comprise a multi-modality communication that corresponds to the textual communication modality and to the voice communication modality.

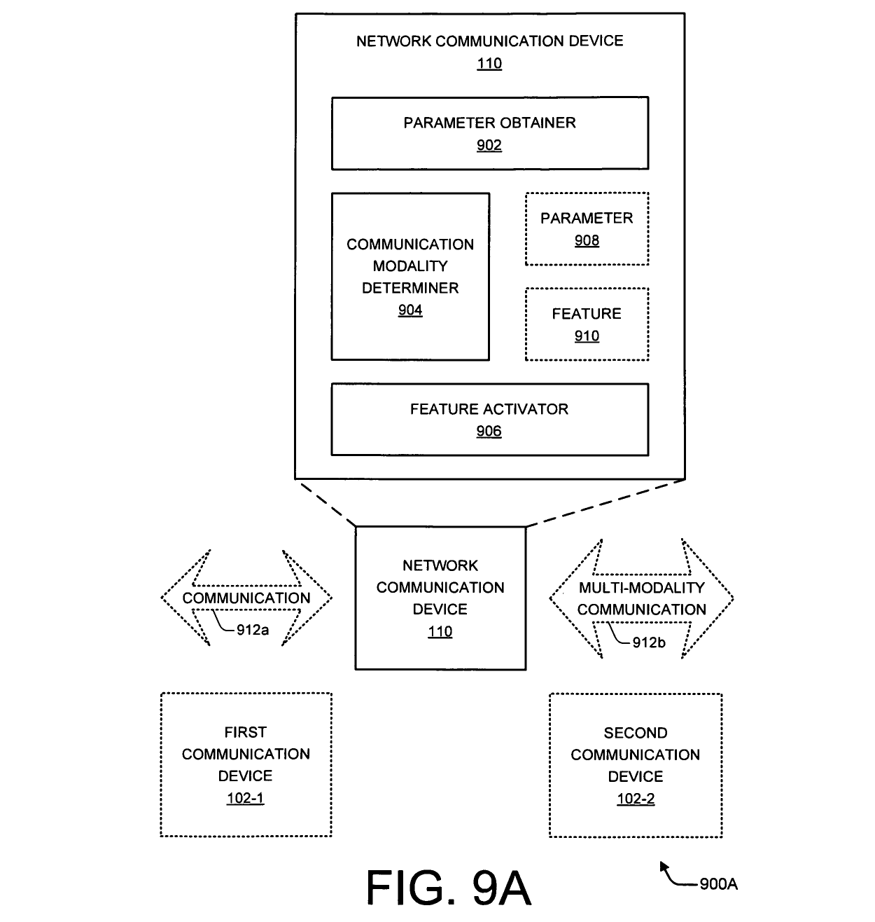

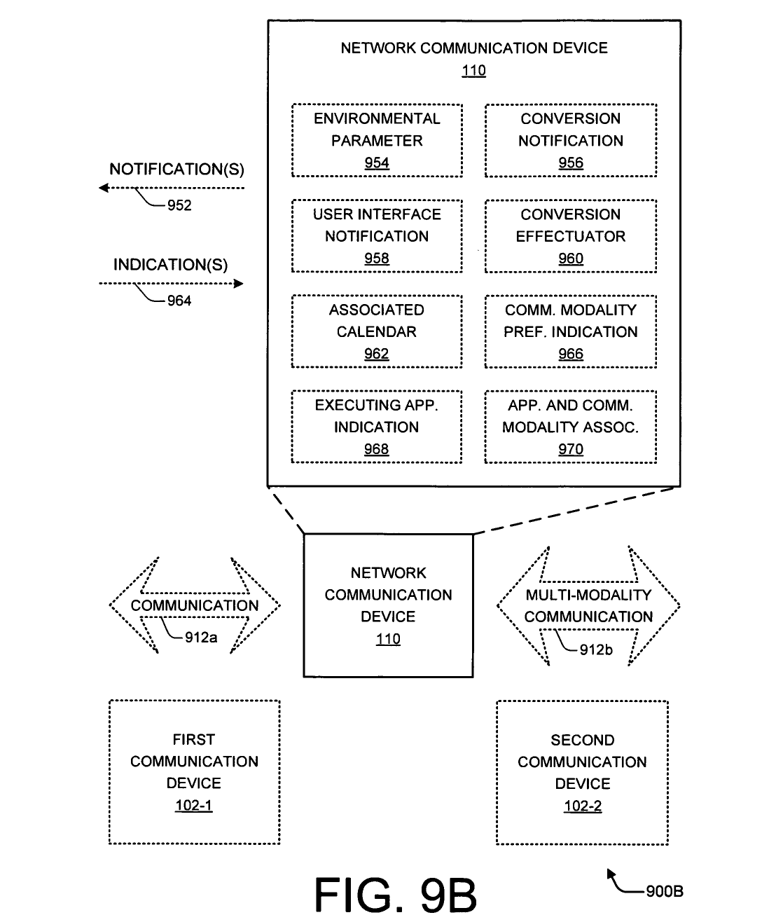

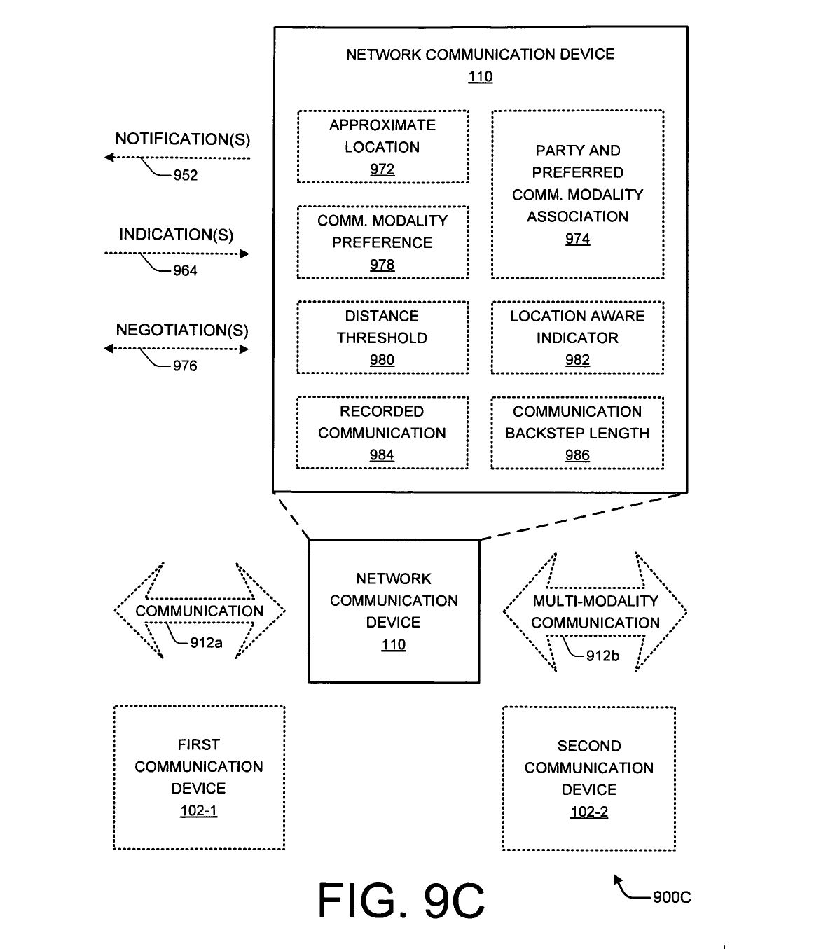

FIG. 9A is a schematic diagram 900A including an example network communication device to automatically activate a feature for multi-modality communication in accordance with certain example embodiments. As shown in FIG. 9A, by way of example but not limitation, schematic diagram 900A may include at least one network communication device 110 or at least one communication 912. More specifically, schematic diagram 900A may include a first communication device 102-1, a second communication device 102-2, a network communication device 110, a communication 912a, or a multi-modality communication 912b. Moreover, network communication device 110 may include a parameter obtainer 902, a communication modality determiner 904, a feature activator 906, one or more parameters 908, or at least one feature 910. By way of example but not limitation, parameter obtainer 902, communication modality determiner 904, or feature activator 906 may comprise one or more modules, logic, circuitry, any combination thereof, and so forth.

For certain example embodiments, a network communication device 110 for automatic activation of multi-modality communication may comprise: a parameter obtainer 902 for obtaining one or more parameters 908 relating to utilization of a communication device 102 (e.g., a second communication device 102-2); a communication modality determiner 904 for determining that user interaction with communication device 102 is to correspond to a second communication modality 106-2 (e.g., of FIGS. 1 and 2) based, at least partly, on one or more parameters 908 relating to utilization of communication device 102; or a feature activator 906 for activating at least one feature 910 that causes a communication 912a corresponding to a first communication modality 106-1 to comprise a multi-modality communication 912b corresponding to first communication modality 106-1 and to second communication modality 106-2 responsive at least partly to a determination by communication modality determiner 904 that user interaction with communication device 102 is to correspond to second communication modality 106-2. For certain example implementations, a parameter 908 may be received from at least one other device. For certain example implementations, a feature 910 may be implemented, located, realized, activated, any combination thereof, etc. at least partially at one or more other devices.

FIG. 9B is a schematic diagram 900B including a network communication device that depicts example additional or alternative aspects for automatically activating a feature for multi-modality communication in accordance with certain example embodiments. As shown in FIG. 9B, by way of example but not limitation, schematic diagram 900B may include at least one network communication device 110 or at least one communication 912. More specifically, schematic diagram 900B may include a first communication device 102-1, a second communication device 102-2, a network communication device 110, a communication 912a, or a multi-modality communication 912b. Moreover, network communication device 110 may comprise, produce, receive, transmit, manipulate, store, retrieve, any combination thereof, etc. one or more example additional or alternative aspects 952-970.

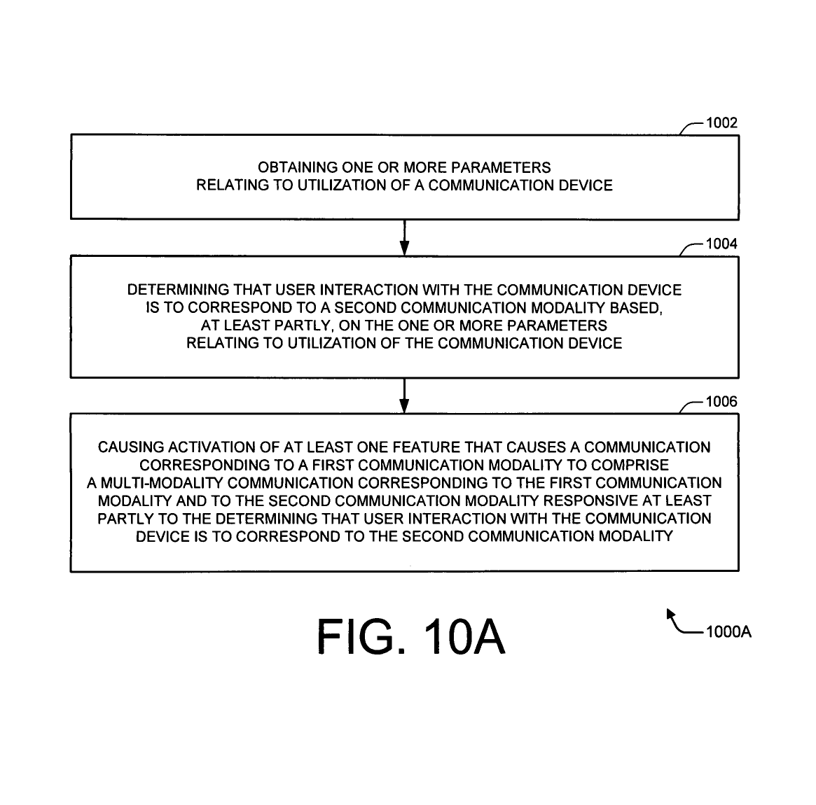

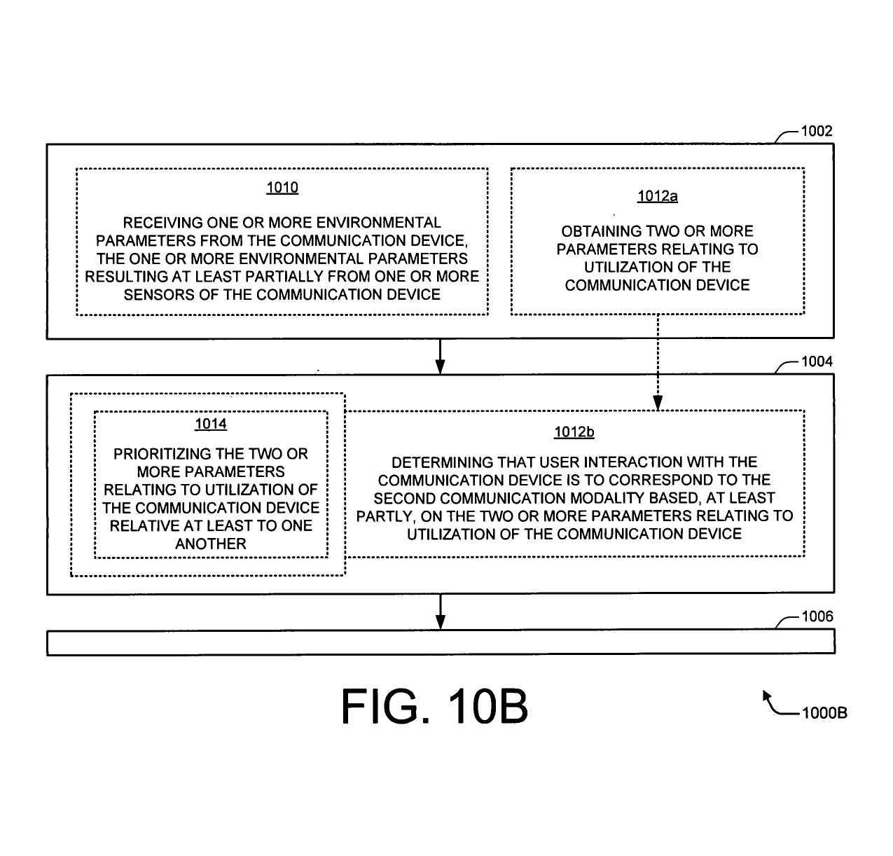

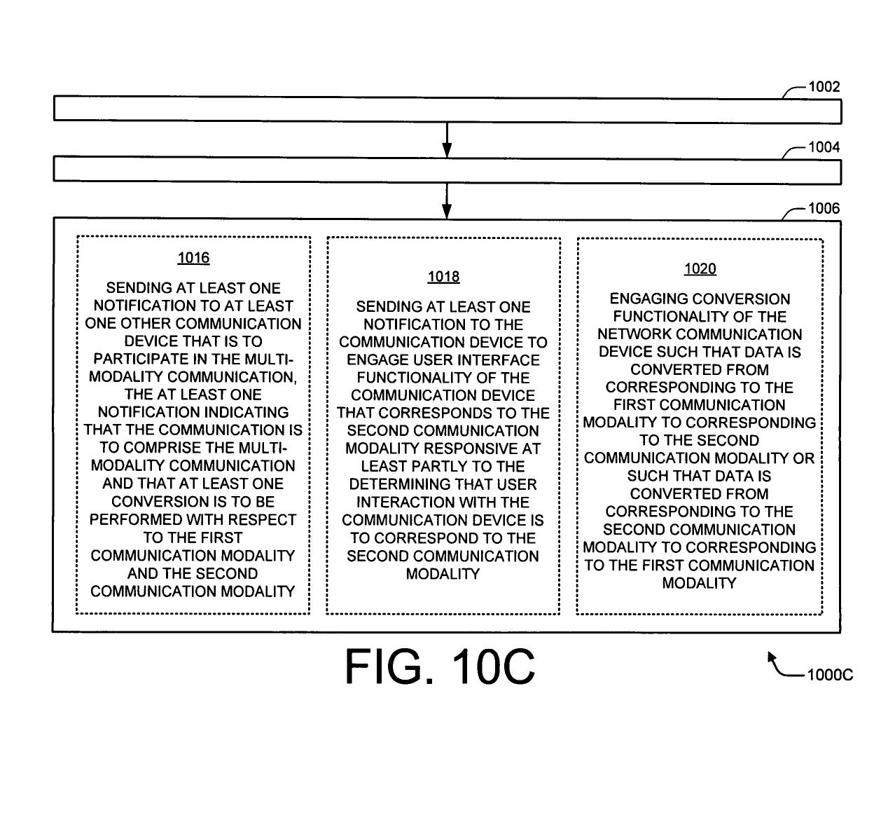

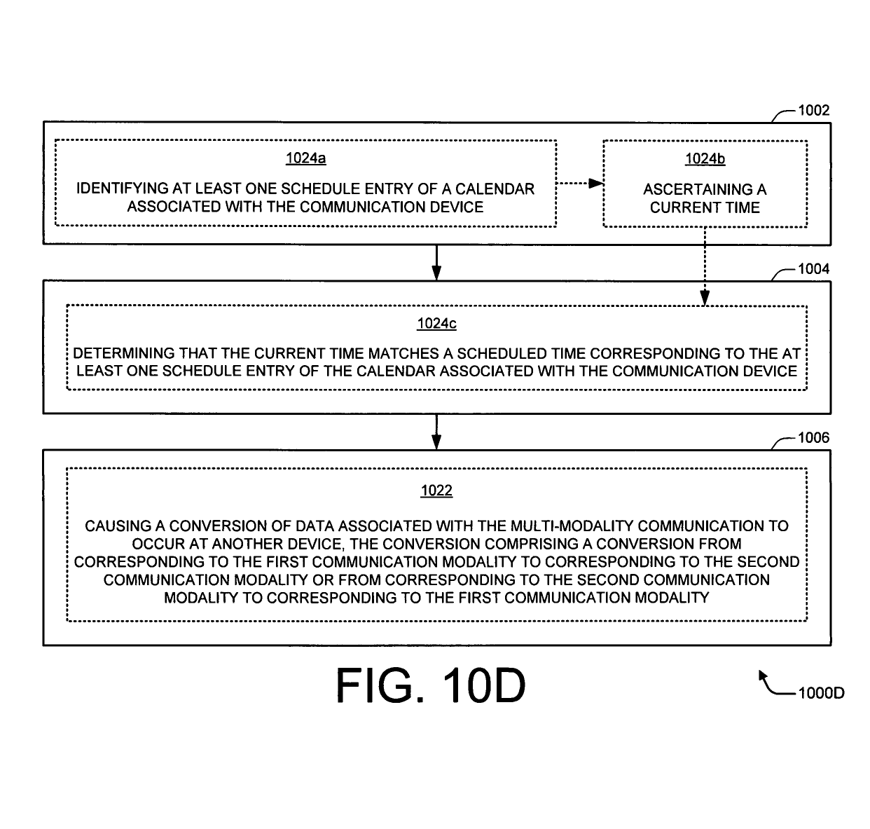

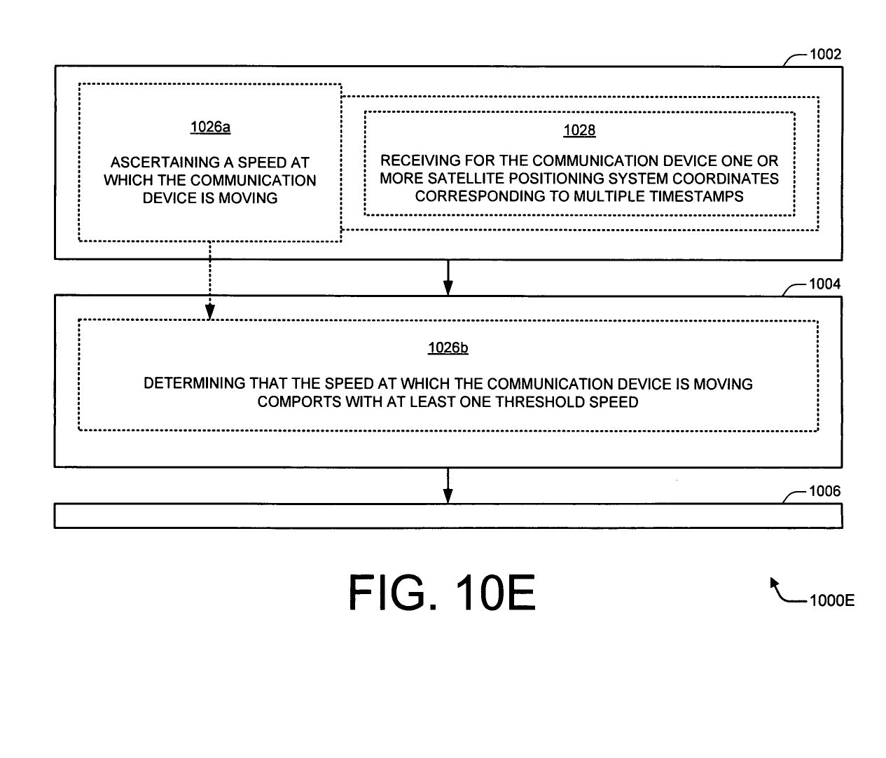

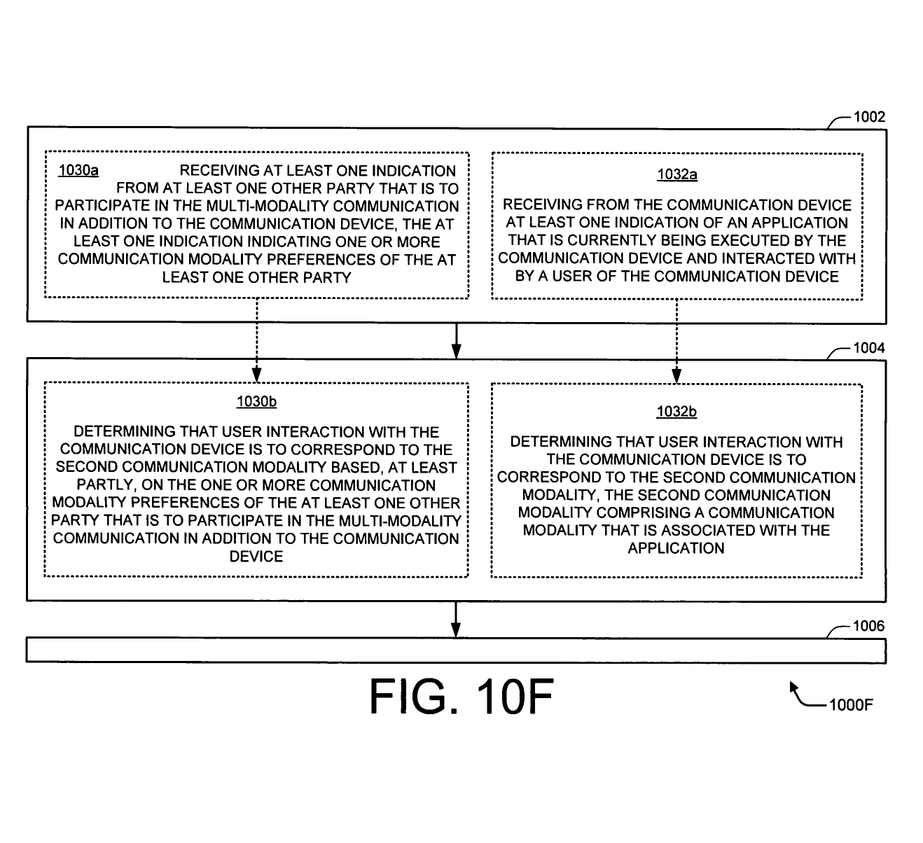

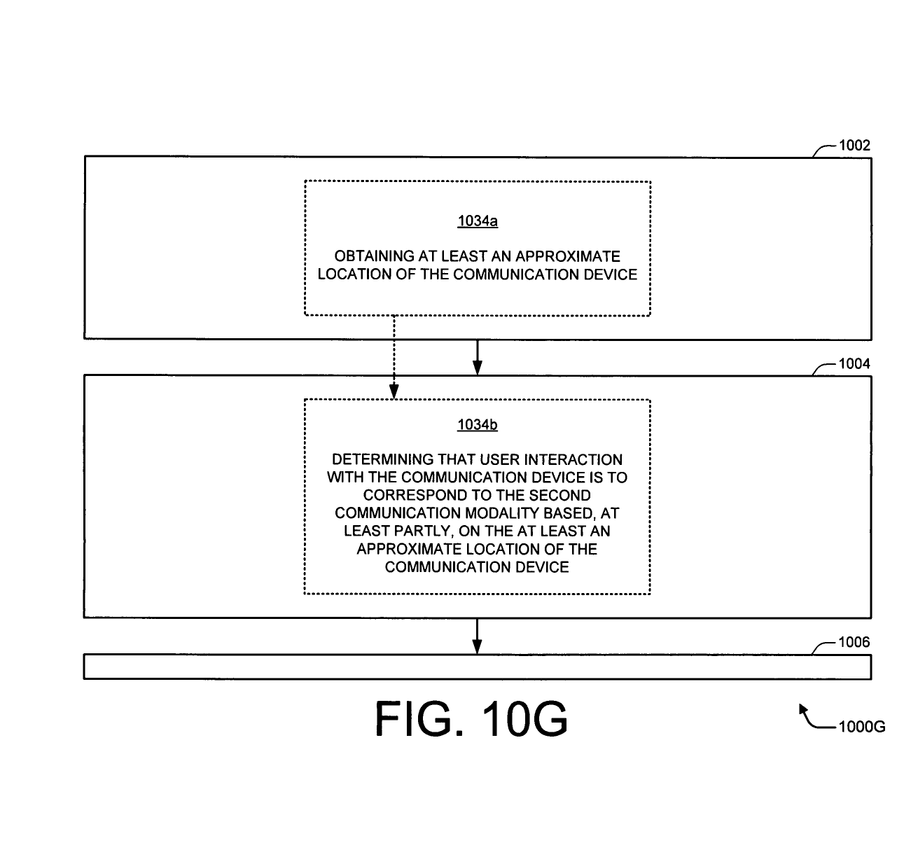

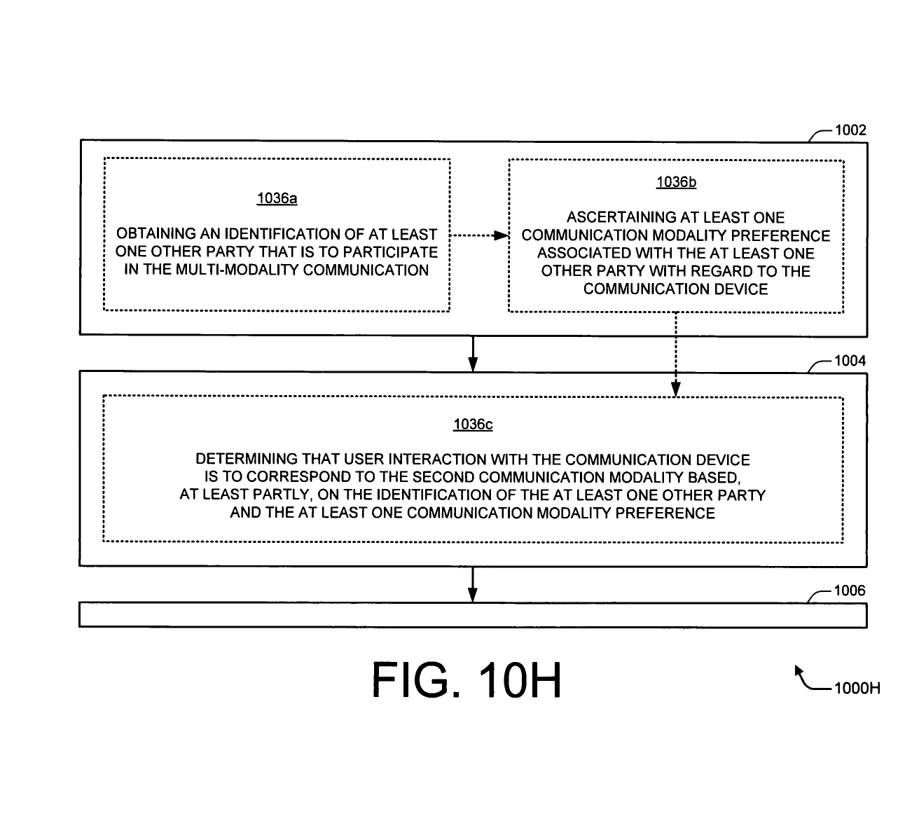

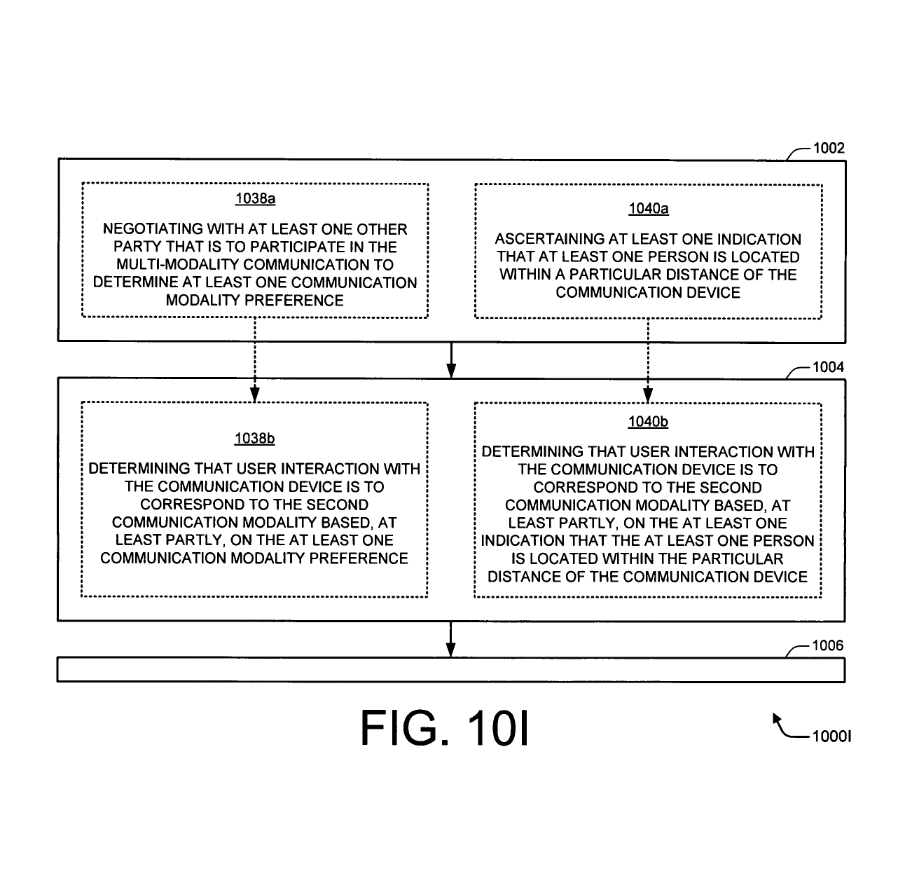

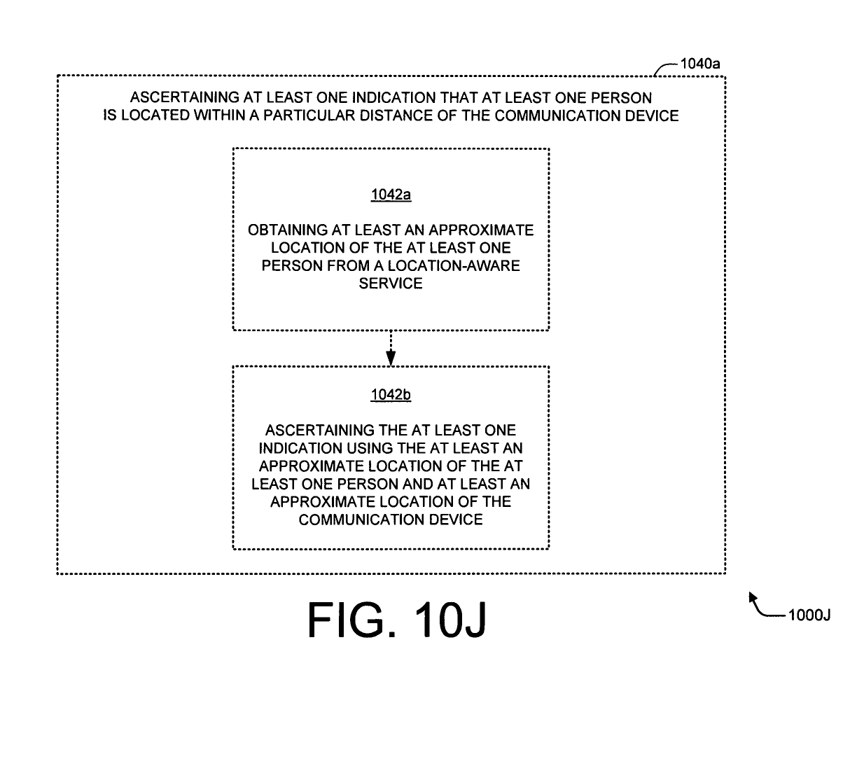

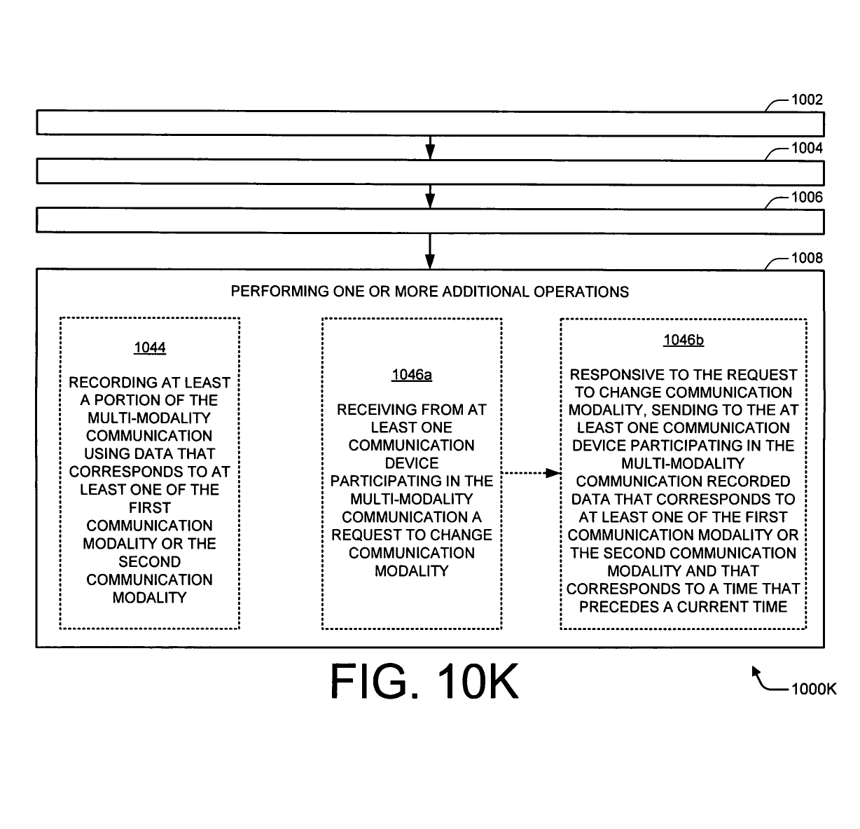

For certain example embodiments, network communication device 110 may include, create, have access to, any combination thereof, etc. one or more of: at least one notification 952, at least one environmental parameter 954, at least one conversion notification 956, at least one user interface notification 958, at least one conversion effectuator 960, at least one associated calendar 962, at least one indication 964, at least one communication modality preference indication 966, at least one executing application indication 968, at least one application and communication modality association 970, any combination thereof, and so forth. Aspects of an example network communication device 110 as depicted in schematic diagram 900B are described further herein below with particular reference at least to FIGS. 10B-10K.

FIG. 9C is a schematic diagram 900C including a network communication device that depicts example additional or alternative aspects for automatically activating a feature for multi-modality communication in accordance with certain example embodiments. As shown in FIG. 9C, by way of example but not limitation, schematic diagram 900C may include at least one network communication device 110 or at least one communication 912. More specifically, schematic diagram 900C may include a first communication device 102-1, a second communication device 102-2, a network communication device 110, a communication 912a, or a multi-modality communication 912b. Moreover, network communication device 110 may comprise, produce, receive, transmit, manipulate, store, retrieve, any combination thereof, etc. one or more example additional or alternative aspects 952, 964, or 972-986.

For certain example embodiments, network communication device 110 may include, create, have access to, any combination thereof, etc. one or more of: at least one notification 952, at least one indication 964, at least one approximate location 972, at least one party and preferred communication modality association 974, at least one negotiation 976, at least one communication modality preference 978, at least one distance threshold 980, at least one location aware indicator 982, at least one recorded communication 984, at least one communication backstep length 986, any combination thereof, and so forth. Aspects of an example network communication device 110 as depicted in schematic diagram 900C are described further herein below with particular reference at least to FIGS. 10B-10K.

FIG. 10A is a flow diagram 1000A illustrating an example method for automatically activating at a network communication device a feature for multi-modality communication in accordance with certain example embodiments. As illustrated, flow diagram 1000A may include any of operations 1002-1006. Although operations 1002-1006 are shown or described in a particular order, it should be understood that methods may be performed in alternative manners without departing from claimed subject matter, including, but not limited to, with a different order or number of operations or with a different relationship between or among operations. Also, at least some operations of flow diagram 1000A may be performed so as to be fully or partially overlapping with other operation(s).

For certain example embodiments, a method for automatic activation of multi-modality communication, which method may be at least partially implemented using hardware, such as that of a network communication device, may comprise an operation 1002, an operation 1004, or an operation 1006. An operation 1002 may be directed at least partially to obtaining one or more parameters relating to utilization of a communication device. By way of example but not limitation, a network communication device 110 may obtain one or more parameters 908 relating to utilization of a communication device (e.g., a second communication device 102-2). For certain example implementations, one or more parameters 908 may be obtained by detecting at least one parameter using at least one sensor of network communication device 110 (e.g., a sensor that is coupled to or accessible from a network communication device 110), receiving at least one parameter from a source that is external to network communication device 110 (e.g., from a first communication device 102-1, a second communication device 102-2, another network communication device, any combination thereof, etc.), retrieving at least one parameter (e.g., as at least part of at least one setting, default value, any combination thereof, etc.) from a memory of network communication device 110, acquiring at least one parameter from another network communication device, acquiring at least one parameter from an initiating or terminating communication device (e.g., as part of a communication initiation message or messages, as part of a notification message for a communication, as part of a negotiation for a communication, a combination thereof, etc.), any combination thereof, and so forth. For certain example implementations, a parameter 908 may relate to utilization of a communication device if it relates to where a communication device is being used, if it relates to when a communication device is being used, if it relates to how a communication device is being used, if it relates to who (locally or remotely) is using a communication device (e.g., if it relates to a second user 104-2 that is interacting with a second communication device 102-2, if it relates to a first user 104-1 that is a party to a communication including second communication device 102-2, a combination thereof, etc.), if it relates to why a communication device is being used, any combination thereof, and so forth. Examples of parameters 908 are described herein, including herein below with particular reference to FIGS. 10B-10K. However, claimed subject matter is not limited to any particular described embodiments, implementations, examples, etc.

For certain example embodiments, an operation 1004 may be directed at least partially to determining that user interaction with the communication device is to correspond to a second communication modality based, at least partly, on the one or more parameters relating to utilization of the communication device. By way of example but not limitation, a network communication device 110 may determine that user interaction with e.g. second communication device 102-2 is to correspond to a second communication modality 106-2 based, at least partly, on one or more parameters 908 relating to utilization of second communication device 102-2. For certain example implementations, a network communication device 110 may determine that a particular communication modality (e.g., a second communication modality 106-2) is to be adopted for user interaction (e.g., interaction by a second user 104-2) with respect to a given communication regardless of which other communication modality or modalities (e.g., a first communication modality 106-1) is to correspond to the given communication based at least partially on one or more parameters 908 that relate to utilization of second communication device 102-2. However, claimed subject matter is not limited to any particular described embodiments, implementations, examples, etc.

For certain example embodiments, an operation 1006 may be directed at least partially to causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality. By way of example but not limitation, a network communication device 110 may cause activation of at least one feature that causes a communication 912a corresponding to a first communication modality 106-1 to comprise a multi-modality communication 912b corresponding to first communication modality 106-1 and to a second communication modality 106-2 responsive at least partly to a determination that user interaction (e.g., by a second user 104-2) with second communication device 102-2 is to comprise second communication modality 106-2. For certain example implementations, a network communication device may cause activation of a feature that effectuates a conversion from one communication modality to another communication modality, a feature that notifies a user (e.g., a user of the communication device or another user of another communication device that is a party to a communication) that a multi-modality communication is being established, a feature that notifies a communication device to activate a feature that enables a user interface input or output component to accept user input or provide user output in accordance with second communication modality 106-2 (e.g., that activates a text-based application for a voice call, that activates a microphone for a text message, a combination thereof, etc.), any combination thereof, and so forth. However, claimed subject matter is not limited to any particular described embodiments, implementations, examples, etc.

For certain example embodiments, a conversion may be effectuated by performing a conversion at a network communication device, by causing a conversion to be performed at a communication device (e.g., that is prompting a transformation of a communication to a multi-modality communication), by causing a conversion to be performed at another communication device (e.g., that is associated with another party to a communication), any combination thereof, and so forth. By way of example but not limitation, a conversion may be performed at a network communication device that is to propagate data traffic for a communication regardless of whether a multi-modality conversion is to be performed (e.g., if a network communication device intercepts data along a communication flow path), at a network communication device that would not otherwise be propagating data traffic for a communication but for a multi-modality conversion (e.g., if a communication flow path is redirected through a network communication device for multi-modality purposes), at a network communication device that is being used to farm out a conversion (e.g., wherein a network communication device sends data to another network communication device and receives converted data back from the other network communication device), any combination thereof, and so forth. Examples of communication paths and conversion scenarios 300A-300H are described herein above with particular reference at least to FIGS. 3A-3H. However, claimed subject matter is not limited to any particular described embodiments, implementations, examples, etc.

FIGS. 10B-10K depict example additions or alternatives for a flow diagram of FIG. 10A in accordance with certain example embodiments. As illustrated, flow diagrams of FIGS. 10B-10K may include any of the illustrated or described operations. Although operations are shown or described in a particular order, it should be understood that methods may be performed in alternative manners without departing from claimed subject matter, including, but not limited to, with a different order or number of operations or with a different relationship between or among operations. Also, at least some operations of flow diagrams of FIGS. 10B-10K may be performed so as to be fully or partially overlapping with other operation(s).

FIG. 10B illustrates a flow diagram 1000B having example operations 1010, 1012a, 1012b, or 1014. For certain example embodiments, an operation 1010 may be directed at least partially to wherein the obtaining one or more parameters relating to utilization of a communication device (of operation 1002) comprises receiving one or more environmental parameters from the communication device, the one or more environmental parameters resulting at least partially from one or more sensors of the communication device. By way of example but not limitation, a network communication device 110 may receive one or more environmental parameters 954 from a communication device 102 (e.g., a second communication device 102-2), wherein one or more environmental parameters 954 may correspond to one or more environmental parameters 754 (e.g., of FIG. 7B) that result at least partially from one or more sensors of second communication device 102-2. By way of example but not limitation, a second communication device 102-2 may detect one or more environmental parameters 754 using one or more sensors 752. Sensors 752 may include, by way of example only, a camera, a microphone, an accelerometer, a thermometer, a satellite positioning system (SPS) sensor, a barometer, a humidity sensor, a compass, a gyroscope, a magnetometer, a pressure sensor, an oscillator, a light sensor, an inertial measurement unit (IMU), multiple ones thereof, any combination thereof, and so forth. Environmental parameters 754 may include, by way of example only, an image, a sound recording, an acceleration value, a temperature, SPS coordinates, a barometric pressure, a humidity level, a compass direction, a gyroscopic value, a magnetic reading, a pressure value, an oscillation value, an ambient light reading, inertial readings, any combination thereof, and so forth. However, claimed subject matter is not limited to any particular described embodiments, implementations, examples, etc.

For certain example embodiments, an operation 1012 (e.g., an operation 1012a or 1012b) may be directed at least partially to wherein: the obtaining one or more parameters relating to utilization of a communication device (of operation 1002) comprises obtaining two or more parameters relating to utilization of the communication device (for operation 1012a) and the determining that user interaction with the communication device is to correspond to a second communication modality based, at least partly, on the one or more parameters relating to utilization of the communication device (of operation 1004) comprises determining that user interaction with the communication device is to correspond to the second communication modality based, at least partly, on the two or more parameters relating to utilization of the communication device (for operation 1012b). By way of example but not limitation, a network communication device 110 may obtain two or more parameters 908 relating to utilization of a communication device 102 (e.g., a second communication device 102-2) or determine that user interaction with second communication device 102-2 is to correspond to a second communication modality 106-2 based, at least partly, on the two or more parameters 908 relating to utilization of second communication device 102-2. Two or more parameters 908 may include, by way of example only, a time and a schedule entry, a time and a location, a location and an identity of another party, a temperature and an ambient noise level, an identity of a person that is within sensory range of a device and a calling party, any combination thereof, and so forth. For certain example implementations, additionally or alternatively, multiple respective parameters 908 may be compared to multiple respective thresholds in at least one matrix to determine that user interaction is to correspond to a second communication modality 106-2. However, claimed subject matter is not limited to any particular described embodiments, implementations, examples, etc.

For certain example embodiments, an operation 1014 may be directed at least partially to wherein the determining that user interaction with the communication device is to correspond to the second communication modality based, at least partly, on the two or more parameters relating to utilization of the communication device (of operation 1012b) comprises prioritizing the two or more parameters relating to utilization of the communication device relative at least to one another. By way of example but not limitation, two or more parameters 908 may be prioritized such that if two or more communication modalities 106 that respectively result from an analysis of two or more parameters 908 are in conflict during an operation of determining, a higher priority communication modality may be determined based at least partly on a prioritization of the two or more parameters 908. For certain example implementations, a user 104 associated with a communication device 102 may be empowered to prioritize two or more parameters 908. For instance, an identity of a caller may be prioritized higher than a schedule entry, or an ambient sound level may be prioritized higher than a location. For certain example implementations, additionally or alternatively, matrix components and respective thresholds may be prioritized. However, claimed subject matter is not limited to any particular described embodiments, implementations, examples, etc.

FIG. 10C illustrates a flow diagram 1000C having example operations 1016, 1018, or 1020. For certain example embodiments, an operation 1016 may be directed at least partially to wherein the causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality (of operation 1006) comprises sending at least one notification to at least one other communication device that is to participate in the multi-modality communication, the at least one notification indicating that the communication is to comprise the multi-modality communication and that at least one conversion is to be performed with respect to the first communication modality and the second communication modality. By way of example but not limitation, a network communication device 110 may send at least one notification 952 (e.g., a conversion notification 956) to at least one other communication device 102 (e.g., a first communication device 102-1) that is to participate in a multi-modality communication 912b, with conversion notification 956 indicating that communication 912a is to comprise multi-modality communication 912b and that at least one conversion is to be performed with respect to first communication modality 106-1 and second communication modality 106-2 (e.g., data corresponding to one communication modality 106 may be converted to data corresponding to another communication modality 106). Although an arrow may be illustrated in a particular direction (e.g., a notification 952 is illustrated as an example outgoing notification in FIG. 9B), associated communications may be exchanged, transmitted, received, any combination thereof, etc. in a different direction or in both directions. For certain example implementations, a conversion notification 956 may indicate who or what device is performing a conversion, may provide conversion or multi-modality communication options for first communication device 102-1, may include an invitation to negotiate conversion or multi-modality communication options, any combination thereof, and so forth. However, claimed subject matter is not limited to any particular described embodiments, implementations, examples, etc.

For certain example embodiments, an operation 1018 may be directed at least partially to wherein the causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality (of operation 1006) comprises sending at least one notification to the communication device to engage user interface functionality of the communication device that corresponds to the second communication modality responsive at least partly to the determining that user interaction with the communication device is to correspond to the second communication modality. By way of example but not limitation, a network communication device 110 may send at least one notification 952 (e.g., a user interface notification 958) to a second communication device 102-2 notifying (e.g., instructing, commanding, requesting, any combination thereof, etc.) it to engage user interface functionality 760 thereof that corresponds to a second communication modality 106-2 responsive at least partly to the determining that user interaction with second communication device 102-2 is to correspond to second communication modality 106-2. For certain example implementations, user interface functionality 760 (e.g., of second communication device 102-2) may comprise an application or a part of an operating system that facilitates interaction in accordance with second communication modality 106-2, may comprise a hardware input or output interface component that facilitates interaction in accordance with second communication modality 106-2, any combination thereof, and so forth. However, claimed subject matter is not limited to any particular described embodiments, implementations, examples, etc.

For certain example embodiments, an operation 1020 may be directed at least partially to wherein the causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality (of operation 1006) comprises engaging conversion functionality of the network communication device such that data is converted from corresponding to the first communication modality to corresponding to the second communication modality or such that data is converted from corresponding to the second communication modality to corresponding to the first communication modality. By way of example but not limitation, a network communication device 110 may engage conversion functionality such that data is converted from corresponding to a first communication modality 106-1 to corresponding to a second communication modality 106-2 or such that data is converted from corresponding to second communication modality 106-2 to corresponding to first communication modality 106-1. For certain example implementations, a network communication device 110 may engage a converter 202c (e.g., of FIG. 2) to convert data corresponding to a first communication modality 106-1 that is received from a first communication device 102-1 into data corresponding to a second communication modality 106-2 prior to sending it to a second communication device 102-2 or to convert data corresponding to a second communication modality 106-2 that is received from second communication device 102-2 into data corresponding to first communication modality 106-1 prior to its transmission to first communication device 102-1. However, claimed subject matter is not limited to any particular described embodiments, implementations, examples, etc.

FIG. 10D illustrates a flow diagram 1000D having example operations 1022, 1024a, 1024b, or 1024c. For certain example embodiments, an operation 1022 may be directed at least partially to wherein the causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality (of operation 1006) comprises causing a conversion of data associated with the multi-modality communication to occur at another device, the conversion comprising a conversion from corresponding to the first communication modality to corresponding to the second communication modality or from corresponding to the second communication modality to corresponding to the first communication modality. By way of example but not limitation, a network communication device 110 may cause a conversion of data associated with a multi-modality communication 912b to occur at another device, with the conversion comprising a conversion from corresponding to a first communication modality 106-1 to corresponding to a second communication modality 106-2 or from corresponding to second communication modality 106-2 to corresponding to first communication modality 106-1. For certain example implementations, a conversion effectuator 960 of a network communication device 110 may cause another device (e.g., a first communication device 102-1, a second communication device 102-2, a different network communication device 110, a combination thereof, etc.) to perform a conversion for a multi-modality communication 912b (e.g., by sending a request to convert, by sending a notification that a conversion is applicable, by sending a command to perform a conversion, by sending one or more variables indicating how a conversion is to be performed, by sending data that is to be converted, a combination thereof, etc.). However, claimed subject matter is not limited to any particular described embodiments, implementations, examples, etc.

For certain example embodiments, an operation 1024 (e.g., an operation 1024a, 1024b, or 1024c) may be directed at least partially to wherein: the obtaining one or more parameters relating to utilization of a communication device (of operation 1002) comprises identifying at least one schedule entry of a calendar associated with the communication device (for operation 1024a) and ascertaining a current time (for operation 1024b); and the determining that user interaction with the communication device is to correspond to a second communication modality based, at least partly, on the one or more parameters relating to utilization of the communication device (of operation 1004) comprises determining that the current time matches a scheduled time corresponding to the at least one schedule entry of the calendar associated with the communication device (for operation 1024c). By way of example but not limitation, a network communication device 110 may identify at least one schedule entry of a calendar that is associated with the device (e.g., an associated calendar 962) or may ascertain a current time, which may include a day or a date. For certain example implementations, an associated calendar 962 may be stored at least partially at a network communication device, may be accessible from the network communication device, may be associated with an owner of a communication device, may be associated with a user of the communication device, may be associated with an account that is linked to the communication device, any combination thereof, and so forth. By way of example but not limitation, a network communication device 110 may further determine that a current time matches a scheduled time corresponding to at least one schedule entry of a calendar that is associated with a communication device. A current time may match a scheduled time if, for example, the current time (or day/date and time) falls within a timeframe (which may include an extended window on either or both sides of a start time or an end time) of a scheduled time of a schedule entry. For certain example implementations, a user may prefer to accept voice call communications as corresponding at least partially to text at a device of the user during a scheduled event, such as a meeting or appointment, that corresponds to a schedule entry of a calendar. However, claimed subject matter is not limited to any particular described embodiments, implementations, examples, etc.

FIG. 10E illustrates a flow diagram 1000E having example operations 1026a, 1026b, or 1028. For certain example embodiments, an operation 1026 (e.g., an operation 1026a or 1026b) may be directed at least partially to wherein: the obtaining one or more parameters relating to utilization of a communication device (of operation 1002) comprises ascertaining a speed at which the communication device is moving (for operation 1026a) and the determining that user interaction with the communication device is to correspond to a second communication modality based, at least partly, on the one or more parameters relating to utilization of the communication device (of operation 1004) comprises determining that the speed at which the communication device is moving comports with at least one threshold speed (for operation 1026b). By way of example but not limitation, a network communication device 110 may ascertain a speed at which a communication device 102 (e.g., a second communication device 102-2) is moving or may determine that the ascertained speed at which second communication device 102-2 is moving comports with at least one threshold speed. For certain example implementations, a threshold speed may correspond to a speed (e.g., approximately 8-12 miles per hour) at which it may be inferred that a person is positioned on a moving vehicle, such as a car, a bus, or a bicycle. If a communication device is positioned on a moving vehicle, visually-oriented user interaction modalities (e.g., text or video) may be avoided via at least one communication modality conversion (e.g., to voice). For certain example implementations, a network communication device 110 may ascertain a speed at which a communication device is moving by receiving a speed (e.g., from a second communication device 102-2, from another network communication device 110, a combination thereof, etc.), by receiving data enabling a computation of speed (e.g., multiple location-timestamp pairs), any combination thereof, and so forth. For certain example implementations, additionally or alternatively, a network communication device 110 may determine that user interaction with the communication device is to correspond to a second communication modality based, at least partly, on at least one movement pattern sample 766 (e.g., of FIG. 7B) corresponding to transport movement within a vehicle or at least one detected movement pattern 764, which may be received from a second communication device 102-2. However, claimed subject matter is not limited to any particular described embodiments, implementations, examples, etc.

For certain example embodiments, an operation 1028 may be directed at least partially to wherein the ascertaining a speed at which the communication device is moving (of operation 1026a) comprises receiving for the communication device one or more satellite positioning system coordinates corresponding to multiple timestamps. By way of example but not limitation, a network communication device 110 may receive for a second communication device 102-2 one or more satellite positioning system (SPS) (e.g., GPS) coordinates that correspond to multiple timestamps. For certain example implementations, SPS coordinates may be received from a second communication device 102-2, from a location service provider, any combination thereof, etc., or SPS coordinates in conjunction with corresponding timestamps may be used to determine a speed of second communication device 102-2. However, claimed subject matter is not limited to any particular described embodiments, implementations, examples, etc.

FIG. 10F illustrates a flow diagram 1000F having example operations 1030a, 1030b, 1032a, or 1032b. For certain example embodiments, an operation 1030 (e.g., an operation 1030a or 1030b) may be directed at least partially to wherein: the obtaining one or more parameters relating to utilization of a communication device (of operation 1002) comprises receiving at least one indication from at least one other party that is to participate in the multi-modality communication in addition to the communication device, the at least one indication indicating one or more communication modality preferences of the at least one other party (for operation 1030a) and the determining that user interaction with the communication device is to correspond to a second communication modality based, at least partly, on the one or more parameters relating to utilization of the communication device (of operation 1004) comprises determining that user interaction with the communication device is to correspond to the second communication modality based, at least partly, on the one or more communication modality preferences of the at least one other party that is to participate in the multi-modality communication in addition to the communication device (for operation 1030b). By way of example but not limitation, a network communication device 110 may receive at least one indication 964 (e.g., a communication modality preference indication 966) from at least one other party (e.g., a first user 104-1, a first communication device 102-1, any combination thereof, etc.) that is to participate in a multi-modality communication 912b along with second communication device 102-2, with at least one communication modality preference indication 966 indicating one or more communication modality preferences of the at least one other party. By way of further example but not limitation, a network communication device 110 may determine that user interaction with second communication device 102-2 is to correspond to second communication modality 106-2 based, at least partly, on the one or more communication modality preferences of the at least one other party that is to participate in multi-modality communication 912b along with second communication device 102-2. For certain example implementations, a second user 104-2 of a second communication device 102-2 may prohibit a particular type of communication modality 106, but permit a first user 104-1 of a first communication device 102-1 to otherwise select a communication modality for user interaction at second communication device 102-2 by second user 104-2. However, claimed subject matter is not limited to any particular described embodiments, implementations, examples, etc.

For certain example embodiments, an operation 1032 (e.g., an operation 1032a or 1032b) may be directed at least partially to wherein: the obtaining one or more parameters relating to utilization of a communication device (of operation 1002) comprises receiving from the communication device at least one indication of an application that is currently being executed by the communication device and interacted with by a user of the communication device (for operation 1032a) and the determining that user interaction with the communication device is to correspond to a second communication modality based, at least partly, on the one or more parameters relating to utilization of the communication device (of operation 1004) comprises determining that user interaction with the communication device is to correspond to the second communication modality, the second communication modality comprising a communication modality that is associated with the application (for operation 1032b). By way of example but not limitation, a network communication device 110 may receive from a communication device 102 (e.g., a second communication device 102-2) at least one indication 964 (e.g., an executing application indication 968) that an application is currently being executed by second communication device 102-2 and interacted with by a second user 104-2 (e.g., that a given application is running and is at least partially visible to or receiving input from or providing output to a user). By way of further example but not limitation, a network communication device 110 may determine that user interaction with second communication device 102-2 is to correspond to a second communication modality 106-2, with second communication modality 106-2 comprising a communication modality 106 that is associated with the executing application. For certain example implementations, an application and communication modality association 970 (e.g., which may comprise a single entry for a single application, a table including applications and associated communication modalities, a table having communication modalities and applications listed under a respective communication modality, a combination thereof, etc.) may be stored to or retrieved from memory to determine a particular communication modality that is associated with a given application. For certain example implementations, an application and communication modality association 970 may be received from a second communication device 102-2, may be similar or analogous to an application and communication modality association 768, any combination thereof, and so forth. For instance, a user may not want any screen real estate consumed by a texting application if the user is playing a given game, so a voice communication modality may be associated with the given game such that texting communications are converted to vocal user interaction. Additionally or alternatively, a user that is listening to music via a music application may want incoming voice communications to be converted to a multi-modality communication having textual interaction for the user. Additionally or alternatively, a user that is interacting with a video communication application may want incoming voice communications to be automatically converted at least partially to text to facilitate multi-tasking or carrying on at least two different communications. However, claimed subject matter is not limited to any particular described embodiments, implementations, examples, etc.

FIG. 10G illustrates a flow diagram 1000G having example operations 1034a or 1034b. For certain example embodiments, an operation 1034 (e.g., an operation 1034a or 1034b) may be directed at least partially to wherein: the obtaining one or more parameters relating to utilization of a communication device (of operation 1002) comprises obtaining at least an approximate location of the communication device (for operation 1034a) and the determining that user interaction with the communication device is to correspond to a second communication modality based, at least partly, on the one or more parameters relating to utilization of the communication device (of operation 1004) comprises determining that user interaction with the communication device is to correspond to the second communication modality based, at least partly, on the at least an approximate location of the communication device (for operation 1034b). By way of example but not limitation, a network communication device 110 may obtain at least an approximate location 972 of a communication device 102 (e.g., a second communication device 102-2). For certain example implementations, at least an approximate location 972 of a device may comprise SPS coordinates (e.g., to a desired, attainable, or permissible level of accuracy); an address; a location indicated by a user; an area, region, or neighborhood; a destination; a location derived from one or more Wi-Fi networks, at least one cellular base station, or SPS coordinates; a location gleaned from a calendar associated with the device; a location inferred from a time of day or day of week; any combination thereof, and so forth. For certain example implementations, an approximate location 972 may be received from a communication device 102, may be received from another network communication device 110, may be derived from one or more positional indicators that are received from a communication device 102 or another network communication device 110, any combination thereof, and so forth. By way of further example but not limitation, a network communication device 110 may determine that user interaction with a second communication device 102-2 is to correspond to a second communication modality 106-2 based, at least partly, on at least an approximate location 972 of second communication device 102-2. Additionally or alternatively, a network communication device 110 may obtain at least an approximate location of another communication device (e.g., a first communication device 102-1) or may determine that user interaction with a second communication device 102-2 is to correspond to a second communication modality 106-2 based, at least partly, on at least an approximate location of first communication device 102-1. However, claimed subject matter is not limited to any particular described embodiments, implementations, examples, etc.

FIG. 10H illustrates a flow diagram 1000H having example operations 1036a, 1036b, or 1036c. For certain example embodiments, an operation 1036 (e.g., an operation 1036a, 1036b, or 1036c) may be directed at least partially to wherein: the obtaining one or more parameters relating to utilization of a communication device (of operation 1002) comprises obtaining an identification of at least one other party that is to participate in the multi-modality communication (for operation 1036a) and ascertaining at least one communication modality preference associated with the at least one other party with regard to the communication device (for operation 1036b); and the determining that user interaction with the communication device is to correspond to a second communication modality based, at least partly, on the one or more parameters relating to utilization of the communication device (of operation 1004) comprises determining that user interaction with the communication device is to correspond to the second communication modality based, at least partly, on the identification of the at least one other party and the at least one communication modality preference (for operation 1036c). By way of example but not limitation, a network communication device 110 may obtain an identification of at least one other party (e.g., a first user 104-1, a first communication device 102-1, a combination thereof, etc.) that is to participate in a multi-modality communication 912b (e.g., in addition to a second user 104-2 or a second communication device 102-2) or ascertain a communication modality preference that is associated with the at least one other party based at least partially on a party and preferred communication modality association 974. For certain example implementations, a party and preferred communication modality association 974 may be received from a second communication device 102-2, may be similar or analogous to a party and preferred communication modality association 770, any combination thereof, and so forth. For certain example implementations, an identification of another party to a communication may obtained by an inspection of a communication initiation message (e.g., by extracting at least one destination identifier, by extracting caller identification data, any combination thereof, etc.), may be obtained in response to a request, may be obtained via an indication or an incoming notification, any combination thereof, and so forth. For certain example implementations, a party and preferred communication modality association 974 may include at least one entry that associates (e.g., links) a person (e.g., individually or as a member of a group) or a device (e.g., individually or as a member of a group) to a preferred communication modality. A party and preferred communication modality association 974 may be realized, by way of example only, as a table linking individuals or groups (e.g., by name, by physical or email address, by virtual handle, by phone number, by device identifier, a combination thereof, etc.) to a respective one or more preferred communication modalities. Additionally or alternatively, a party and preferred communication modality association 974 may be realized as a respective block of a respective contact entry for an individual or a group. A party and preferred communication modality association 974 may be stored at a network communication device 110 or remotely. By way of further example but not limitation, a network communication device 110 may further determine that user interaction is to correspond to a second communication modality 106-2 based, at least partly, on the identification of the at least one other party and the communication modality preference ascertained from a party and preferred communication modality association 974. For certain example implementations, a user may prefer that incoming voice communications from a parent be converted to a textual mode of interaction, may prefer that a textual communication from a significant other be converted to a video communication modality, may prefer that an incoming video communication from anyone that is part of a particular company (e.g., a place of employment) be converted to voice interaction, a combination thereof, and so forth. However, claimed subject matter is not limited to any particular described embodiments, implementations, examples, etc.

FIG. 10I illustrates a flow diagram 1000J having example operations 1038a, 1038b, 1040a, or 1040b. For certain example embodiments, an operation 1038 (e.g., an operation 1038a or 1038b) may be directed at least partially to wherein: the obtaining one or more parameters relating to utilization of a communication device (of operation 1002) comprises negotiating with at least one other party that is to participate in the multi-modality communication to determine at least one communication modality preference (for operation 1038a); and the determining that user interaction with the communication device is to correspond to a second communication modality based, at least partly, on the one or more parameters relating to utilization of the communication device (of operation 1004) comprises determining that user interaction with the communication device is to correspond to the second communication modality based, at least partly, on the at least one communication modality preference (for an operation 1038b). By way of example but not limitation, a network communication device 110 may negotiate with (e.g., request communication modality preferences from, send communication modality options to, exchange communication modality capabilities with, any combination thereof, etc.) at least one other party that is to participate in a multi-modality communication 912b to determine at least one communication modality preference 978 for the other party. Another party may comprise, by way of example only, a first user 104-1, a first communication device 102-1, a third user (not explicitly shown) for a teleconference, a third communication device (not explicitly shown) for a teleconference, any combination thereof, and so forth. For certain example implementations, a negotiation may entail falling back to at least one second choice communication modality preference 978 (e.g., in lieu of a first chose communication modality preference 978) by either or both of another party or network communication device 110 (e.g., on behalf of a second user 104-2, a second communication device 102-2, any combination thereof, etc.). By way of further example but not limitation, a network communication device 110 may determine that user interaction with second communication device 102-2 is to correspond to second communication modality 106-2 based, at least partly, on at least one communication modality preference 978. However, claimed subject matter is not limited to any particular described embodiments, implementations, examples, etc.

For certain example embodiments, an operation 1040 (e.g., an operation 1040a or 1040b) may be directed at least partially to wherein: the obtaining one or more parameters relating to utilization of a communication device (of operation 1002) comprises ascertaining at least one indication that at least one person is located within a particular distance of the communication device (for operation 1040a) and the determining that user interaction with the communication device is to correspond to a second communication modality based, at least partly, on the one or more parameters relating to utilization of the communication device (of operation 1004) comprises determining that user interaction with the communication device is to correspond to the second communication modality based, at least partly, on the at least one indication that the at least one person is located within the particular distance of the communication device (for operation 1040b). By way of example but not limitation, a network communication device 110 may ascertain at least one indication that at least one person is located within a particular distance (e.g., a distance threshold 980) of a communication device 102 (e.g., a second communication device 102-2) or determine that user interaction is to correspond to a second communication modality 106-2 based, at least partly, on the at least one indication that the at least one person is located within the particular distance to second communication device 102-2. For certain example implementations, a network communication device 110 may ascertain at least one indication that at least one person is located within a particular distance of a second communication device 102-2 based at least partly on “absolute” location data (e.g., SPS coordinates of a device associated with a person, location data from a location-aware web service, a combination thereof, etc.), “relative” location data (e.g., detection of proximity of a person by at least one communication device sensor, detection of proximity of a communication device associated with a person by at least one communication device sensor, a combination thereof, etc.), any combination thereof, and so forth. For certain example implementations, a network communication device 110 may be configured to switch to a particular communication modality 106 if a given person is determined to be within a distance threshold 980 of a communication device 102, including but not limited to while a communication is occurring, when a communication is being established, any combination thereof, and so forth. For certain example implementations, a distance threshold 980 may be received from a second communication device 102-2, may be similar or analogous to a distance threshold 776, may be settable by a user, any combination thereof, and so forth. However, claimed subject matter is not limited to any particular described embodiments, implementations, examples, etc.

FIG. 10J illustrates a flow diagram 1000J having example operations 1042a or 1042b. For certain example embodiments, an operation 1042 (e.g., an operation 1042a or 1042b) may be directed at least partially to wherein the ascertaining at least one indication that at least one person is located within a particular distance of the communication device (of operation 1040a) comprises: obtaining at least an approximate location of the at least one person from a location-aware service (for operation 1042a) and ascertaining the at least one indication using the at least an approximate location of the at least one person and at least an approximate location of the communication device (for operation 1042b). By way of example but not limitation, at least an approximate location (e.g., a location or location range to a technically-feasible accuracy, a location or a location range to a legally-permissible accuracy, a location or location range to a user-permitted or specified level of accuracy, a combination thereof, etc.) of at least one person may be obtained from at least one location-aware service. A location-aware service may include, by way of example only, a service that is provided from or by a network communication device 110 (e.g., one that is capable of activating a feature for multi-modality communication, one that is separate from a network communication device that is capable of activating a feature for a multi-modality communication, any combination thereof, etc.), a service that is provided from or by an internet company, a service that pushes location updates to a communication device 102 or a network communication device 110, a service that enables a communication device or a network communication device to pull (e.g., request or retrieve) location updates, a service that a user 104 of a communication device may register for, a service that persons whose locations are being tracked or updated (e.g., by checking in at a location, by being associated with a device that is being tracked, a combination thereof, etc.) may register for, any combination thereof, and so forth. A network communication device 110 may use a location aware indicator 982, which may comprise an indication of an “absolute” location of a person, an indication of a “relative” proximity of a person to communication device 102, an indication that a communication device 102 is logged into a location-aware service, an indication that a person's location is being updated by a location-aware service, any combination thereof, and so forth. For certain example implementations, a location aware indicator 982 may be received from a second communication device 102-2 or from a location-aware service, may be similar or analogous to a location aware indicator 778, any combination thereof, and so forth. By way of further example but not limitation, at least one indication may be ascertained by a network communication device 110 using an approximate location of at least one person and at least an approximate location (e.g., an approximate location 972) of a communication device 102 in conjunction with at least one distance threshold (e.g., a distance threshold 980—which may have a same or a different value as compared to any other distance threshold(s)). For instance, an indication may be ascertained if a difference between a location of a person (e.g., as determinable from a location-aware indicator 982) and an approximate location 972 of a communication device 102 is less than a distance threshold 980. However, claimed subject matter is not limited to any particular described embodiments, implementations, examples, etc.

For certain example embodiments, at least an approximate location of at least one person may be obtained via an image from an imaging sensor of a camera of a communication device 102 (e.g., a second communication device 102-2). By way of example but not limitation, an image may be sent from a second communication device 102-2 to a network communication device 110 for comparison with person image samples (e.g., person image samples 780), a result of an image comparison at a second communication device 102-2 may be sent to a network communication device 110, any combination thereof, and so forth. For certain example embodiments, at least an approximate location of at least one person may be obtained via an establishment of a direct wireless link between a second communication device 102-2 and at least one other communication device 102 that is associated with the at least one person, and the at least one indication may be ascertained responsive at least partly to establishment of the direct wireless link. For certain example embodiments, a parameter relating to utilization of a communication device may comprise an ambient sound level or an ambient sound threshold in a vicinity of a communication device (e.g., an ambient sound level that is detectable by one or more microphones of a communication device). By way of example but not limitation, an ambient sound level, an ambient sound threshold, a result of a comparison including an ambient sound level or an ambient sound threshold, may be sent from a second communication device 102-2 to a network communication device 110 for a determination of if user interaction with second communication device 102-2 is to correspond to a second communication modality 106-2.

FIG. 10K illustrates a flow diagram 1000K having example operations 1008, 1044, 1046a, or 1046b. As illustrated, one or more operations 1008 may be performed in addition to those operations 1002, 1004, or 1006 of flow diagram 1000A. For certain example embodiments, an operation 1044 may be directed at least partially to recording at least a portion of the multi-modality communication using data that corresponds to at least one of the first communication modality or the second communication modality. By way of example but not limitation, a network communication device 110 may record (e.g., store, save, write, any combination thereof, etc. to one or more media) at least a portion of a multi-modality communication 912b using data that corresponds to at least one of a first communication modality 106-1 or a second communication modality 106-2. For certain example implementations, a network communication device 110 may create or maintain a record of data corresponding to a first communication modality 106-1, data corresponding to a second communication modality 106-2, data corresponding to both a first and a second communication modality 106-1 and 106-2, and so forth (e.g., may create or maintain a recorded communication 984). A recorded communication 984 may extend from a beginning of a communication to a present time; may extend backward a particular period of time (e.g., 10 seconds) that may be preset or adjustable by a user, a communication device, a service provider, a network communication device, any combination thereof, etc.; may extend backward for a particular number of communication exchanges (e.g., a most recent “x” times a person transmitted data corresponding to text, voice, video, etc.); any combination thereof; and so forth. However, claimed subject matter is not limited to any particular described embodiments, implementations, examples, etc.

For certain example embodiments, an operation 1046 (e.g., an operation 1046a or 1046b) may be directed at least partially to receiving from at least one communication device participating in the multi-modality communication a request to change communication modality (for operation 1046a) and responsive to the request to change communication modality, sending to the at least one communication device participating in the multi-modality communication recorded data that corresponds to at least one of the first communication modality or the second communication modality and that corresponds to a time that precedes a current time (for operation 1046b). By way of example but not limitation, a network communication device 110 may receive from at least one communication device (e.g., a second communication device 102-2) that is participating in a multi-modality communication 912b a request (e.g., via an indication 964, a notification 952, a combination thereof, etc.) to change communication modality (e.g., from second communication modality 106-2 to a first communication modality 106-1 or to a third communication modality). By way of further example but not limitation, responsive to a request to change communication modality, a network communication device 110 may send to at least one communication device (e.g., second communication device 102-2) that is participating in a multi-modality communication 912b recorded data (e.g., at least a portion of recorded communication 984) that corresponds to at least one of first communication modality 106-1 or second communication modality 106-2 and that corresponds to a time that precedes a current time. For certain example implementations, if a second user 104-2 is switching from user interaction corresponding to a second communication modality 106-2 to user interaction corresponding to a first communication modality 106-1, network communication device 110 may send to second communication device 102-2 at least a portion (e.g., a few seconds of data; a most recently-received conversational snippet, such as a single text or a continuous voice transmission without interrupting silence; a combination thereof; etc.) of recorded communication 984 that precedes a current time in a data form that corresponds to a communication modality to which a user is switching. An amount that data precedes a current time may be determinable by a communication backstep length 986. A communication backstep length 986 may, by way of example only, be specified in terms of time, data, bandwidth, number of transmissions/receptions, number of texts, amount of speech since a most-recent previous pause, any combination thereof, and so forth. A communication backstep length 986 may be provided to a network communication device 110 from a communication device 102, may be settable by a user or network operator, any combination thereof, and so forth. Providing a previous portion of a conversation in a “new” communication modality may provide context, ensure that a conversation continues smoothly, any combination thereof, and so forth. For certain example implementations, communication data for a previous time may be sent from a network communication device 110 to a second communication device 102-2 for presentation to a second user 104-2. Such communication data may have previously been sent in a different form—e.g., data that corresponds to a first communication modality 106-1 and that is being sent in response to a request to change communication modality may have previously been sent as data corresponding to a second communication modality 106-2. However, claimed subject matter is not limited to any particular described embodiments, implementations, examples, etc.

It should be appreciated that the particular embodiments (e.g., processes, apparatuses, systems, media, arrangements, etc.) described herein are merely possible implementations of the present disclosure, and that the present disclosure is not limited to the particular implementations described herein or shown in the accompanying figures.

In addition, in alternative implementations, certain acts, operations, etc. need not be performed in the order described, and they may be modified and/or may be omitted entirely, depending on the circumstances. Moreover, in various implementations, the acts or operations described may be implemented by a computer, controller, processor, programmable device, or any other suitable device, and may be based on instructions stored on one or more computer-readable or processor-accessible media or otherwise stored or programmed into such devices. If computer-readable media are used, the computer-readable media may be, by way of example but not limitation, any available media that can be accessed by a device to implement the instructions stored thereon.

Various methods, systems, techniques, etc. have been described herein in the general context of processor-executable instructions, such as program modules, executed by one or more processors or other devices. Generally, program modules may include routines, programs, objects, components, data structures, combinations thereof, etc. that perform particular tasks or implement particular abstract data types. Typically, functionality of program modules may be combined or distributed as desired in various alternative embodiments. In addition, embodiments of methods, systems, techniques, etc. may be stored on or transmitted across some form of device-accessible media.

It may also be appreciated that there may be little distinction between hardware implementations and software implementations for aspects of systems, methods, etc. that are disclosed herein. Use of hardware or software may generally be a design choice representing cost vs. efficiency tradeoffs, for example. However, in certain contexts, a choice between hardware and software (e.g., for an entirety or a given portion of an implementation) may become significant. Those having skill in the art will appreciate that there are various vehicles by which processes, systems, technologies, etc. described herein may be effected (e.g., hardware, software, firmware, combinations thereof, etc.), and that a preferred vehicle may vary depending upon a context in which the processes, systems, technologies, etc. are deployed. For example, if an implementer determines that speed and accuracy are paramount, an implementer may opt for a mainly hardware and/or firmware vehicle. Alternatively, if flexibility is deemed paramount, an implementer may opt for a mainly software implementation. In still other implementations, an implementer may opt for some combination of hardware, software, and/or firmware. Hence, there are multiple possible vehicles by which processes and/or devices and/or other technologies described herein may be effected. Which vehicle may be desired over another may be a choice dependent upon a context in which a vehicle is to be deployed or specific concerns (e.g., speed, flexibility, predictability, etc.) of an implementer, any of which may vary. Those skilled in the art will recognize that optical aspects of example implementations may employ optically-oriented hardware, software, and/or firmware.

Those skilled in the art will recognize that it is common within the art to describe devices and/or processes in fashion(s) as set forth herein, and thereafter use standard engineering practices to realize such described devices and/or processes into workable systems having described functionality. That is, at least a portion of the devices and/or processes described herein may be realized via a reasonable amount of experimentation.

Aspects and drawings described herein illustrate different components contained within, or connected with, other different components. It is to be understood that such depicted architectures are presented merely by way of example, and that many other architectures may be implemented to achieve identical or similar functionality. In a conceptual sense, any arrangement of components to achieve described functionality may be considered effectively “associated” such that desired functionality is achieved. Hence, any two or more components herein combined to achieve a particular functionality may be seen as “associated with” each other such that desired functionality is achieved, irrespective of architectures or intermedial components. Likewise, any two or more components so associated can also be viewed as being “operably connected” or “operably coupled” (or “operatively connected,” or “operatively coupled”) to each other to achieve desired functionality, and any two components capable of being so associated can also be viewed as being “operably couplable” (or “operatively couplable”) to each other to achieve desired functionality. Specific examples of operably couplable include, but are not limited to, physically mateable and/or physically interacting components and/or wirelessly interactable and/or wirelessly interacting components and/or logically interacting and/or logically interactable components.

Those skilled in the art will recognize that at least some aspects of embodiments disclosed herein may be implemented at least partially via integrated circuits (ICs), as one or more computer programs running on one or more computing devices, as one or more software programs running on one or more processors, as firmware, as any combination thereof, and so forth. It will be further understood that designing circuitry and/or writing code for software and/or firmware may be accomplished by a person skilled in the art in light of the teachings and explanations of this disclosure.

The foregoing detailed description has set forth various example embodiments of devices and/or processes via the use of block diagrams, flowcharts, examples, combinations thereof, etc. Insofar as such block diagrams, flowcharts, examples, combinations thereof, etc. may contain or represent one or more functions and/or operations, it will be understood by those within the art that each function and/or operation within such block diagrams, flowcharts, examples, combination thereof, etc. may be implemented, individually and/or collectively, by a wide range of hardware, software, firmware, any combination thereof, and so forth. For example, in some embodiments, one or more portions of subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of example embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, as virtually any combination thereof, etc. and that designing circuitry and/or writing code for software and/or firmware is within the skill of one of skill in the art in light of the teachings of this disclosure.

In addition, those skilled in the art will appreciate that the mechanisms of subject matter described herein are capable of being distributed as a program product in a variety of forms, and that an illustrative embodiment of subject matter described herein applies regardless of a particular type of signal-bearing media used to actually carry out the distribution. Examples of a signal-bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

Although particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that inventive subject matter is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two item,” without other modifiers, typically means at least two recitations, or two or more recitations).

As a further example of “open” terms in the present specification including the claims, it will be understood that usage of a language construction of “A or B” is generally interpreted, unless context dictates otherwise, as a non-exclusive “open term” meaning: A alone, B alone, and/or A and B together. Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

Although various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for automatic activation of multi-modality communication, the method being at least partially implemented by a network communication device, the method comprising:
obtaining one or more parameters relating to utilization of a communication device;
determining that user interaction with the communication device is to correspond to a second communication modality based, at least partly, on the one or more parameters relating to utilization of the communication device; and
causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality.

2. The method of claim 1, wherein the obtaining one or more parameters relating to utilization of a communication device comprises:
receiving one or more environmental parameters from the communication device, the one or more environmental parameters resulting at least partially from one or more sensors of the communication device.

3. The method of claim 1, wherein:
the obtaining one or more parameters relating to utilization of a communication device comprises:
obtaining two or more parameters relating to utilization of the communication device; and
the determining that user interaction with the communication device is to correspond to a second communication modality based, at least partly, on the one or more parameters relating to utilization of the communication device comprises:
determining that user interaction with the communication device is to correspond to the second communication modality based, at least partly, on the two or more parameters relating to utilization of the communication device.

4. The method of claim 3, wherein the determining that user interaction with the communication device is to correspond to the second communication modality based, at least partly, on the two or more parameters relating to utilization of the communication device comprises:
prioritizing the two or more parameters relating to utilization of the communication device relative at least to one another.

5. The method of claim 1, wherein the causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality comprises:
sending at least one notification to at least one other communication device that is to participate in the multi-modality communication, the at least one notification indicating that the communication is to comprise the multi-modality communication and that at least one conversion is to be performed with respect to the first communication modality and the second communication modality.

6. The method of claim 1, wherein the causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality comprises:
sending at least one notification to the communication device to engage user interface functionality of the communication device that corresponds to the second communication modality responsive at least partly to the determining that user interaction with the communication device is to correspond to the second communication modality.

7. The method of claim 1, wherein the causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality comprises:
engaging conversion functionality of the network communication device such that data is converted from corresponding to the first communication modality to corresponding to the second communication modality or such that data is converted from corresponding to the second communication modality to corresponding to the first communication modality.

8. The method of claim 1, wherein the causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality comprises:
causing a conversion of data associated with the multi-modality communication to occur at another device, the conversion comprising a conversion from corresponding to the first communication modality to corresponding to the second communication modality or from corresponding to the second communication modality to corresponding to the first communication modality.

9. The method of claim 1, wherein:
the obtaining one or more parameters relating to utilization of a communication device comprises:
identifying at least one schedule entry of a calendar associated with the communication device; and
ascertaining a current time; and
the determining that user interaction with the communication device is to correspond to a second communication modality based, at least partly, on the one or more parameters relating to utilization of the communication device comprises:
determining that the current time matches a scheduled time corresponding to the at least one schedule entry of the calendar associated with the communication device.

10. The method of claim 1, wherein:
the obtaining one or more parameters relating to utilization of a communication device comprises:
ascertaining a speed at which the communication device is moving; and
the determining that user interaction with the communication device is to correspond to a second communication modality based, at least partly, on the one or more parameters relating to utilization of the communication device comprises:
determining that the speed at which the communication device is moving comports with at least one threshold speed.

11. The method of claim 10, wherein the ascertaining a speed at which the communication device is moving comprises:
receiving for the communication device one or more satellite positioning system coordinates corresponding to multiple timestamps.

12. The method of claim 1, wherein:
the obtaining one or more parameters relating to utilization of a communication device comprises:
receiving at least one indication from at least one other party that is to participate in the multi-modality communication in addition to the communication device, the at least one indication indicating one or more communication modality preferences of the at least one other party; and
the determining that user interaction with the communication device is to correspond to a second communication modality based, at least partly, on the one or more parameters relating to utilization of the communication device comprises:
determining that user interaction with the communication device is to correspond to the second communication modality based, at least partly, on the one or more communication modality preferences of the at least one other party that is to participate in the multi-modality communication in addition to the communication device.

13. The method of claim 1, wherein:
the obtaining one or more parameters relating to utilization of a communication device comprises:
receiving from the communication device at least one indication of an application that is currently being executed by the communication device and interacted with by a user of the communication device; and
the determining that user interaction with the communication device is to correspond to a second communication modality based, at least partly, on the one or more parameters relating to utilization of the communication device comprises:
determining that user interaction with the communication device is to correspond to the second communication modality, the second communication modality comprising a communication modality that is associated with the application.

14. The method of claim 1, wherein:
the obtaining one or more parameters relating to utilization of a communication device comprises:
obtaining at least an approximate location of the communication device; and
the determining that user interaction with the communication device is to correspond to a second communication modality based, at least partly, on the one or more parameters relating to utilization of the communication device comprises:
determining that user interaction with the communication device is to correspond to the second communication modality based, at least partly, on the at least an approximate location of the communication device.

15. The method of claim 1, wherein:
the obtaining one or more parameters relating to utilization of a communication device comprises:
obtaining an identification of at least one other party that is to participate in the multi-modality communication; and
ascertaining at least one communication modality preference associated with the at least one other party with regard to the communication device; and
the determining that user interaction with the communication device is to correspond to a second communication modality based, at least partly, on the one or more parameters relating to utilization of the communication device comprises:
determining that user interaction with the communication device is to correspond to the second communication modality based, at least partly, on the identification of the at least one other party and the at least one communication modality preference.

16. The method of claim 1, wherein:
the obtaining one or more parameters relating to utilization of a communication device comprises:
negotiating with at least one other party that is to participate in the multi-modality communication to determine at least one communication modality preference; and
the determining that user interaction with the communication device is to correspond to a second communication modality based, at least partly, on the one or more parameters relating to utilization of the communication device comprises:
determining that user interaction with the communication device is to correspond to the second communication modality based, at least partly, on the at least one communication modality preference.

17. The method of claim 1, wherein:
the obtaining one or more parameters relating to utilization of a communication device comprises:
ascertaining at least one indication that at least one person is located within a particular distance of the communication device; and
the determining that user interaction with the communication device is to correspond to a second communication modality based, at least partly, on the one or more parameters relating to utilization of the communication device comprises:
determining that user interaction with the communication device is to correspond to the second communication modality based, at least partly, on the at least one indication that the at least one person is located within the particular distance of the communication device.

18. The method of claim 17, wherein the ascertaining at least one indication that at least one person is located within a particular distance of the communication device comprises:
obtaining at least an approximate location of the at least one person from a location-aware service; and
ascertaining the at least one indication using the at least an approximate location of the at least one person and at least an approximate location of the communication device.

19. The method of claim 1, further comprising:
recording at least a portion of the multi-modality communication using data that corresponds to at least one of the first communication modality or the second communication modality.

20. The method of claim 19, further comprising:
receiving from at least one communication device participating in the multi-modality communication a request to change communication modality; and
responsive to the request to change communication modality, sending to the at least one communication device participating in the multi-modality communication recorded data that corresponds to at least one of the first communication modality or the second communication modality and that corresponds to a time that precedes a current time.

21. A network communication device for automatic activation of multi-modality communication, the network communication device comprising:
circuitry for obtaining one or more parameters relating to utilization of a communication device;
circuitry for determining that user interaction with the communication device is to correspond to a second communication modality based, at least partly, on the one or more parameters relating to utilization of the communication device; and
circuitry for causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality.

22. The network communication device of claim 21, wherein the circuitry for obtaining one or more parameters relating to utilization of a communication device comprises:
circuitry for receiving one or more environmental parameters from the communication device, the one or more environmental parameters resulting at least partially from one or more sensors of the communication device.

23. The network communication device of claim 21, wherein:
the circuitry for obtaining one or more parameters relating to utilization of a communication device comprises:
circuitry for obtaining two or more parameters relating to utilization of the communication device; and
the circuitry for determining that user interaction with the communication device is to correspond to a second communication modality based, at least partly, on the one or more parameters relating to utilization of the communication device comprises:
circuitry for determining that user interaction with the communication device is to correspond to the second communication modality based, at least partly, on the two or more parameters relating to utilization of the communication device.

24. The network communication device of claim 23, wherein the circuitry for determining that user interaction with the communication device is to correspond to the second communication modality based, at least partly, on the two or more parameters relating to utilization of the communication device comprises:
circuitry for prioritizing the two or more parameters relating to utilization of the communication device relative at least to one another.

25. The network communication device of claim 21, wherein the circuitry for causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality comprises:
circuitry for sending at least one notification to at least one other communication device that is to participate in the multi-modality communication, the at least one notification indicating that the communication is to comprise the multi-modality communication and that at least one conversion is to be performed with respect to the first communication modality and the second communication modality.

26. The network communication device of claim 21, wherein the circuitry for causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality comprises:
circuitry for sending at least one notification to the communication device to engage user interface functionality of the communication device that corresponds to the second communication modality responsive at least partly to the determining that user interaction with the communication device is to correspond to the second communication modality.

27. The network communication device of claim 21, wherein the circuitry for causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality comprises:
circuitry for engaging conversion functionality of the network communication device such that data is converted from corresponding to the first communication modality to corresponding to the second communication modality or such that data is converted from corresponding to the second communication modality to corresponding to the first communication modality.

28. The network communication device of claim 21, wherein the circuitry for causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality comprises:
circuitry for causing a conversion of data associated with the multi-modality communication to occur at another device, the conversion comprising a conversion from corresponding to the first communication modality to corresponding to the second communication modality or from corresponding to the second communication modality to corresponding to the first communication modality.

29. The network communication device of claim 21, wherein:
the circuitry for obtaining one or more parameters relating to utilization of a communication device comprises:
circuitry for identifying at least one schedule entry of a calendar associated with the communication device; and
circuitry for ascertaining a current time; and
the circuitry for determining that user interaction with the communication device is to correspond to a second communication modality based, at least partly, on the one or more parameters relating to utilization of the communication device comprises:
circuitry for determining that the current time matches a scheduled time corresponding to the at least one schedule entry of the calendar associated with the communication device.

30-40. (canceled)

41. An apparatus for automatic activation of multi-modality communication, the apparatus comprising:
means for obtaining one or more parameters relating to utilization of a communication device;
means for determining that user interaction with the communication device is to correspond to a second communication modality based, at least partly, on the one or more parameters relating to utilization of the communication device; and
means for causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality.

42. The apparatus of claim 41, wherein the means for obtaining one or more parameters relating to utilization of a communication device comprises:
means for receiving one or more environmental parameters from the communication device, the one or more environmental parameters resulting at least partially from one or more sensors of the communication device.

43. The apparatus of claim 41, wherein:
the means for obtaining one or more parameters relating to utilization of a communication device comprises:
means for obtaining two or more parameters relating to utilization of the communication device; and
the means for determining that user interaction with the communication device is to correspond to a second communication modality based, at least partly, on the one or more parameters relating to utilization of the communication device comprises:
means for determining that user interaction with the communication device is to correspond to the second communication modality based, at least partly, on the two or more parameters relating to utilization of the communication device.

44. The apparatus of claim 43, wherein the means for determining that user interaction with the communication device is to correspond to the second communication modality based, at least partly, on the two or more parameters relating to utilization of the communication device comprises:
means for prioritizing the two or more parameters relating to utilization of the communication device relative at least to one another.

45. The apparatus of claim 41, wherein the means for causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality comprises:
means for sending at least one notification to at least one other communication device that is to participate in the multi-modality communication, the at least one notification indicating that the communication is to comprise the multi-modality communication and that at least one conversion is to be performed with respect to the first communication modality and the second communication modality.

46. The apparatus of claim 41, wherein the means for causing activation of at least one feature that causes a communication corresponding to a first communication modality to comprise a multi-modality communication corresponding to the first communication modality and to the second communication modality responsive at least partly to the determining that user interaction with the communication device is to correspond to the second communication modality comprises:
means for sending at least one notification to the communication device to engage user interface functionality of the communication device that corresponds to the second communication modality responsive at least partly to the determining that user interaction with the communication device is to correspond to the second communication modality.

47-60. (canceled)
